(19) United States
(12) Patent Application Publication
(10) Pub. No.: US 2023/0174767 A1
(43) Pub. Date: Jun. 8, 2023

(54) THERMOPLASTIC POLYMER COMPOSITION COMPRISING POLYROTAXANE

(71) Applicants: The Texas A&M University System, College Station, TX (US); The University of Tokyo, Tokyo (JP)

(72) Inventors: Hung-Jue Sue, College Station, TX (US); Chia-Ying Tsai, College Station, TX (US); Glendimar S. Molero, Mission, TX (US); Kohzo Ito, Tokyo (JP); Koichi Mayumi, Tokyo (JP); Shuntaro Uenuma, Tokyo (JP); Shota Ando, Tokyo (JP)

(73) Assignees: The Texas A&M University System, College Station, TX (US); The University of Tokyo, Tokyo (JP)

(21) Appl. No.: 17/638,364

(22) PCT Filed: Aug. 28, 2020
(86) PCT No.: PCT/JP2020/032509

§ 371 Date: Feb. 25, 2022

Related U.S. Application Data
(60) Provisional application No. 62/893,265, filed on Aug. 29, 2019.

(51) Int. Cl. C08L 33/12; C08J 5/18; C08J 3/00

(52) U.S. Cl. CPC C08L 33/12; C08J 5/18; C08J 3/005; C08L 2203/30; C08J 2333/12; C08J 2400/21

(57) ABSTRACT

A composition includes a thermoplastic polymer and a polyrotaxane. The polyrotaxane includes a plurality of cyclic molecules and a chain polymer passing through the plurality of the cyclic molecules in a skewering manner, at least a part of the hydroxyl groups of the plurality of cyclic molecules being substituted with a hydrophobic group. A group that enhances miscibility of the polyrotaxane to the thermoplastic polymeris bound to at least a part of the hydrophobic groups of each of the plurality of cyclic molecules.

### CROSS-REFERENCE TO RELATED APPLICATIONS

The present application is a 35 U.S.C. § 371 U.S. National Phase entry of, and claims priority to, PCT Application PCT/JP2020/032509 filed Aug. 28, 2020, which claims priority to U.S. Application No. 62/893,265 filed Aug. 29, 2019, both of which are hereby incorporated herein by reference in their entireties for all purposes.

### STATEMENT REGARDING FEDERALLY SPONSORED RESEARCH OR DEVELOPMENT

Not applicable.

### BACKGROUND

The present disclosure relates to a composition comprising a thermoplastic polymer and a polyrotaxane.

Transparent resins that are light-weight and have high impact resistance are used in applications such as automotive lenses, electronic displays, and glass sheet replacements. A typical example of such transparent resins is a thermoplastic resin including polyacrylates such as poiymethyi methacrylate (PMMA) and polycarbonate.

Polyacrylates are esters of alcohol (such as methanol, ethanol and butanol) with either acrylic acid or methacrylic acid. Polyacrylates are excellent in optical properties and durability compared to polycarbonate but have low impact strength and have poor scratch resistance.

Anti-scratch additives for polyacrylates such as PMMA have been described in literature. For example, a combination of acrylic rubbers and a “silicon containing slip agent” have been shown to improve the scratch resistance of PMMA. Fatty acid amides have also been used. These additives have the disadvantage of reducing the transparency of the polyacrylate

“Hard coats” is a process for protecting finished articles that involves adding a thin coating using either a spray process or plasma deposition. Although these can have acceptable transparency, they are expensive to apply because an additional manufacturing operation is needed, and they can have problems with layer separation due to poor interlayer adhesion. Also, complex shapes can be difficult to coat uniformly.

Meanwhile, polyrotaxanes have been added to polylactide, an opaque polyester thermoplastic and to an epoxy thermoset and meth(acrylate).

WO2016/171187 discloses a photocurable composition comprising a polyfunctional (two or more functional) meth(acrylate), a polyrotaxane, silica particles and a photopolymerization initiator, wherein when the content of the polyfunctional meth(acrylate) is X part by mass, the content of the polyrotaxane is Y part by mass, the content of the silica particles is Z part by mass, the relationships of the four formula are satisfied. By providing such photocurable composition, an improvement in surface hardness of the hardened film is addressed.

### SUMMARY

There is a need for a composition comprising a thermoplastic polymer and a polyrotaxane that can improve fracture and/or scratch behaviors of a thermoplastic polymer such as polyacrylates without compromise in modulus and glass-transition temperature. Such composition is particularly useful for clear plastics such as polyacrylates, polycarbonates, polystyrene and low crystallinity po y(ethylene terephthalate) because the polyrotaxane does not significantly reduce the optical clarity of the base polymer.

To solve the above problem, the present disclosure includes the following aspects.

In the first aspect, a composition comprising a thermoplastic polymer and a polyrotaxane is provided. The polyrotaxane includes a plurality of cyclic molecules and a chain polymer passing through the plurality of the cyclic molecules in a skewering manner. At least a part of the hydroxyl groups of the plurality of cyclic molecules is substituted with a hydrophobic group. A group that enhances miscibility of the polyrotaxane to the thermoplastic polymer is bound to at least a part of the hydrophobic groups of each of the plurality of cyclic molecules.

In the second aspect, a method of producing a composition comprising a thermoplastic polymer and a polyrotaxa.ne. The method comprises providing a polyrotaxane and blending the thermoplastic polymer and the polyrotaxane. The polyrotaxane includes a plurality of cyclic molecules and a chain polymer passing through the plurality of the cyclic molecules in a skewering manner. At least a part of the hydroxyl groups of each of the plurality of cyclic molecules is substituted with a hydrophobic group. A group that enhances miscibility of the polyrotaxane to the thermoplastic polymer is bound to at least a part of the hydrophobic groups of each of the plurality of cyclic molecules.

### BRIEF DESCRIPTION OF DRAWINGS

FIG. 1 is a schematic view illustrating preparation of samples of compositions including polymethyl methacrylate (PMMA) and a polyrotaxane,

FIG. 2 is the variations of parameters of the samples (e.g., concentration of polyrotaxane, sample thickness and processing temperature).

FIG. 3 is an overview of procedure to assess scratch visibility.

FIG. 4(A) is a graph of critical load for crack formation of four different samples having a thickness of 0.2 mm. FIG. 4 (B) is a graph of scratch coefficient of fiction (SCOT) versus normal load.

FIG. 5 contains images of the four samples of FIG. 4(A) by confocal laser-scanning confocal microscopy.

FIG. 6 (A) is a graph of critical load for crack formation of four different samples having a thickness of 0.4 mm. FIG. 6(B) is a graph of scratch coefficient of friction (SCOF) versus normal load. FIGS. 6 (C) to (F) are images of the four samples of FIG. 6(A) by confocal laser-scanning confocal microscopy.

FIG. 7(A) is a graph of critical load for crack formation of four different samples having a thickness of 1 mm. FIG. 7(B) is a graph of scratch coefficient of friction (SCOF) versus normal load. FIGS. 7 (C) to (F) are images of the four samples of FIG. 7(A) by confocal laser-scanning confocal microscopy.

FIG. 8(A) is a graph of critical load for crack formation of four different samples having a thickness of 1 mm when samples were processed or hot-processed at 190° C. FIG. 8(B) is a graph of scratch coefficient of fiction (SCOF) versus normal load. FIGS. 8 (C) to (F) are images of the four samples of FIG. 8(A) by confocal laser-scanning confocal microscopy.

FIG. 9 (A) is a graph showing onset loads at Which a visible crack occurs in the four samples having a thickness of 1 mm. FIG. 9(B) are images of the four samples of FIG. 9 (A).

FIG. 10 (A) is a graph showing onset loads at which a visible crack occurs in the four samples having a thickness of 1 mm when samples were processed or hot-processed at 190° C. FIG. 10 (B) are images of the four samples of FIG. 11(A).

FIG. 11 (A) is a graph of depth measured by laser confocal microscopy when the normal load was applied to the four samples having a thickness of 0.2 mm. FIG. 11 (B) shows a three-dimensional image by laser confocal microscopy of the sample containing I wt. % polyrotaxane where a normal load of 50 N was applied. FIG. 11 (C) shows a three-dimensional image by laser confocal microscopy of the neat PMMA where a normal load of SO N was applied.

FIG. 12 illustrates a scheme of a crosslinking reaction between polyrotaxanes.

FIG. 13 (A) is a schematic view of PMMA containing 1 wt. % of polycaprolactone-grafted cyclodextrin (PCL-grafted CD), labeled as PMMA_CD1%. FIG. 13 (B) is a schematic view of PMMA containing 1 wt. % of unmodified polyrotaxane consisting of PCL-grafted CD, labeled as PMMA_uPR1%. FIG. 13 (C) is a schematic view of PMMA containing 1 wt. % of unmodified polyrotaxane consisting of PCL-grafted CD, labeled as PMMA_mPR1%. FIG. 13 (D) is physical properties of the polyrotaxane used for the composition of FIG. 13 (B). FIG. 13 (F) is physical properties of the polyrotaxane used for the composition of FIG. 13 (C).

FIG. 14 is a graph showing the particle size distribution in the sample of PMMA_CD1% hot-pressed at 160° C., the sample of PMMA_uPR1% hot pressed at 160° C., the sample of PMMA_mPR1% hot-pressed at 160° C. and the sample of PMMA MPR M) hot-pressed at 190° C.

FIG. 15(A) is an image of a sample of PMMA_mPR1% hot-pressed at 160° C. by transmission electron microscopy. FIG. 15 (B) is an image of a sample of PMMA . PRI% hot-pressed at 190° C. by transmission electron microscopy.

FIG. 16 (A) is an image of a sample of PMMA_mPR1% hot-pressed at 160° C. by transmission electron microscopy at higher magnification. FIG. 16(B) is an image of a sample of PMMA_mPR1% hot-pressed at 190° C. by transmission electron microscopy at higher magnification.

FIG. 17 is an image of a sample of PMMA_uPR1% hot-pressed at 160° C. by transmission electron microscopy.

FIG. 18 is an image of a sample of PMMA_CD1% hot-pressed at 160° C. by transmission electron microscopy.

FIG. 19 is a graph showing onset loads at which a crack occurs in each of the samples Neat PMMA, PMMA_CD1%, PMMA_uPR1% and PMMA_mPR1% having a thickness of 1.0 mm and hot pressed at 160° C.

FIG. 20 is a graph showing transmittance of each of the samples Neat PMMA, PMMA_CD1%, PMMA_uPR1% and PMMA_mPR1% in the range of the wavelength of 400 to 800 nm.

FIG. 21 (A) is a load versus displacement graph of the samples Neat PMMA, PMMA_CD1%, PMMA_uPR1% and PMMA_mPR1%. FIG. 21 (B) is a table showing K_{IC} values for each sample.

FIG. 22 is microscopic images showing a cracked status. (A) Neat PMMA, (B) PMMA_uPR1% hot-pressed at 190° C., (C) PMMA_mPR1% hot-pressed at 160° C. and (D) PMMA_mPR1% hot-pressed at 190° C. White arrows in (A) and (B) indicate crazes near the crack tip. Scale bars indicate 50 micrometers.

FIG. 23 (A) is an image of a sample of PMMA _{J}riPRi% hot-pressed at 160° C. by transmission electron microscopy. FIG. 23(B) is a magnified image of the boxed portion of FIG. 23 (A).

FIG. 24 (A) is a magnified image of the structure in which particles of polyrotaxane are dispersed in the thermoplastic polymer in thesample hot pressed at 160° C. FIG. 24 (B) is a magnified image of the structure in which particles of polyrotaxane are dispersed in the thermoplastic polymer in the sample hot pressed at 190° C. FIG. 24(C) is a table of residual craze thickness (nm) of the two samples.

FIG. 25 are dynamic storage modulus (E′) and tan δ curves.

FIG. 26 the dielectric loss of Neat PMMA, PMMA_uPR1% and PMMA_mPR1%.

### DETAILED DESCRIPTION OF EMBODIMENTS

In the specification, the terms “a,” “an,” “the,” and similar referents in the context of describing the invention should be construed as including both the singular and the plural, unless otherwise indicated herein or clearly inconsistent with the context.

The composition of the present disclosure is a blend of one or more thermoplastic polymers and a polyrotaxane. The composition can be represented as a blend of thermoplastic polymer molecules and polyrotaxane molecules. The polyrotaxane acts as a scratch-resistant additive for the thermoplastic polymer.

The thermoplastic polymer may include, but is not limited to, polyacrylate such as polymethylmethacrylate; polycarbonates such as bisphenol A polycarbonate; polyolefins such as polyethylene, polypropylene, and polymethylpentene; polystyrene; polyalkylene terephthalate such as polyethylene terephthalate and polybutylene terephthalate; PETG (polyethylene terephthalate glycol-modified); poly oxymethylene; polyvinyl chloride and a combination thereof.

In some embodiments, the thermoplastic polymer is polyacrylate, polycarbonate, polyolefin, polystyrene, polyethylene terephthalate) or a combination thereof. In other embodiments, the thermoplastic polymer is polyacrylate, polycarbonate, polyester, polystyrene, or a combination thereof. In yet other embodiments, the thermoplastic polymer is poly methylmethacrylate, polypropylene, or poly(ethylene terephthalate), or a combination thereof.

In terms of impact resistance and optical property, the thermoplastic polymer preferably includes polymethylmethacrylate, polycarbonate or a combination thereof.

In the specification, polyacrylates refer to esters of alcohols with either acrylic acid or methacrylic acid. Polyacrylates are typically prepared using radical polymerization either in bulk or in suspension giving a polydispersity typically greater than 2. They can also be prepared using anionic initiators to give products with narrow (<1.2) polydispersity

Polycarbonate is typically prepared from a diol, such as bisphenol A, and phosgene in the presence of a base. Alternately, the diol can be reacted with dimethylcarbonate to form the polycarbonate and methanol.

The molecular weight of the thermoplastic polymer such as polyacrylate (e.g. PMMA) and polycarbonate is not particularly limited, but may be 5,000 to 500,000, preferably 10,000 to 500,000 and more preferably 50,000 to 500,000 in terms of improvement in fracture and/or scratch behavior of the composition. In preferred embodiments, the thermoplastic polymers in the composition are not further polymerized each other. In particular. the thermoplastic polymers in the composition are not further polymerized after blending with the polyrotaxane. In other words, the thermoplastic polymer in the composition excludes a thermoplastic resin that is produced by polymerizing the thermoplastic polymers further with a polymerization initiator or optical irradiation. In specific embodiments, 95% or more of the thermoplastic polymers out of the total number of the thermoplastic polymers in the composition is not polymerized each other.

The polyrotaxane is a molecule including at least one cyclic molecule through which has been inserted a chain polymer that has end-groups that are too large to pass through the opening of the cyclic molecule (s). In other words, the polyrota.xane includes at least one cyclic molecule and a chain polymer penetrating through the cyclic molecule to be encircled with the cyclic molec le. All or a part of the hydroxy groups in the cyclic inoleculqs are modified with one or more hydrophobic groups.

The cyclic molecules may include, but are not limited to, cyclodextrins, crown ethers, pillar arenes, calixarenes, cyclophanes, biturils and derivatives thereof. Preferably, the cyclic rrrolecules are cyclodextrin. The cyclodextrin may include α-cyclodextrin, βcyclodextin, γ-cyclodextrin and thereof. The derivatives may include, but are not limited to, methylated α-cyclodextrin, methylated β-cyclodextrin, methylated γ-cyclodextrin, hydroxypropylated α-cyclodextrin, hydroxypropylated β-cyclodextrin, hydroxypropylated γ-cyclodextrin, glycosyl cyclodextrin and the like.

The cyclic molecules in one polyrotaxane molecule may be one kind or two or more kinds. The cyclic molecules in the composition may be one kind or two of more kinds.

The chain polymer is not particularly limited as long as it is a chain polymer passing through the cyclic molecules in a skewering manner. The chain polymer may be linear or branched. The chain polymer may be selected from the group consisting of polyvinyl alcohol, polyvinylpyrrolidone, celluloses (carboxymethylcellulose, hydroxyethylcellulose, hydroxypropylcellulose and the like), polyacrylamide, polyethylene oxide, polyethylene glycol polypropylene glycol, polyvinyl acetal, polyvinyl methyl ether, polyamine, polyethyleneimine, casein, gelatin, starch, polyolefins such as polethylene, polypropylene, and copolymer resins with pther olefinic monomers, polyesters such as polycaprolactone, polyvinyl chloride resins, polystyrenes such as polystyrene, acrylonitrile-styrene copolymer resin and the like, acrylates such as polymethyl methyacrylate, copolymer of (meth)acrylate, acryonitrile-methyl acrylate copolymer and the like, polyearbonates polyurethanes, vinyl chloride-vinyl acetate copolymer, polyvinylbutyral and the like, polyisobutylene, polytetrahydrofuran polyaniline, acrylonitrile-butadiene-styrene copolymer (ABS resin), polyamides, polyimides, polydienes such as polyisoprene, polybutadiene and the like, polysiloxanes such as polydimethylsiloxane and the like, polysulfones, polyimines, polycarboxylic acid anhydrides, polyureas, polysulfides, polyphosphazenes, polyketones, polyphenylenes, polyhaloolefins, and derivatives thereof. As a chain polymer, polyester, polyethylene glycol and polypropylene gylcol are particularly preferred.

The chain polymer of the polyrotaxane has capping groups, i.e., the groups that prevent the cyclic molecules from disengaging from the chain polymer, at the ends. Thus, the both ends of the chain polymer is too large to pass through the cyclic molecules and the cyclic molecules are hold over the chain polymer in a state that the chain polymer passes through the cyclic molecules in a skewing manner,

The capping group is not particularly limited as long as it is placed at the ends of the chain polymer and can prevent the disengagement of the cyclic molecules. For example, the capping group may be select from the group consisting of adamantane groups; dinitrophenyl groups such as 4 -dinitrophenyl and 3,5-dinitrophenyl, dialkylphenyls; cyclodextrins; trityl groups; fluoresceins, pyrenes; substituted benzenes such as alkyl benzene, alkloxy benzene, phenol, halobenzene, cyanobenzene, benzoic acid, amino benzene and the like; polycyclic aromatics which may be substituted; steroids; and derivatives thereof. Proferably, the capping group may be selected from the group consisting, of adamantane groups; dinitrolphenyl groups; cyclodextrins; trity groups; fluoresceins; and pyrenes, more preferably adamantane groups.

The weight average molecular amount of the chain polymer (a part of the chain polymer in the polyrotaxane) is not particularly limited and, for example, may be 1,000 to 500,000. in some embodiments, the weight average molecular amount of the chain polymer (a part of the chain polymer in the polyrotaxane) is 20,000 or less.

The weight average molecular amount of the chain polymer may be measured with gel permeation chromatography (GPC) chain polymer, for example, based on the standard curve created from the elution time and the molecular weight using a chain polymer having a known molecular weight as a standard reagent.

When the chain polymer passes through the cyclic molecules in a skewing manner, the ratio of the amount of the cyclic molecules encircling the chain polymer to the maximum amount of the cyclic molecules encircling the chain polymer is preferably 0.001 to 0.6, more preferably. 0.01 to 0.5 and far more preferably 0.05 to 0.4.

Polyrotaxanes derived from the cyclic molecules have pendant hydroxyl groups that can be modified, either completely or partially, by esterification and etherification. This can be useful to tailor the interaction of the polyrotaxane with the thermoplastic polymer. Examples of such modifications of polyrotaxanes is described in U.S. Pat. No. 7,622,527, for example.

Thus, a whole of or a part of the hydroxyl groups of each of the plurality of cyclic molecules are substituted with a hydrophobic group.

The hydrophobic group may be a polymer chain or oligomer of polyester such as caprola.ctone; alkyl such as propyl, butyl, heptyl, hexyl and the like; polyether such as polypropylene glycol; unsaturated hydrocarbon such as polybutadiene, and the like. The hydrophobic group in one polyrotaxane molecule may be one kind or two or more kinds. The hydrophobic group in the composition may be one kind or two or more kinds.

In some embodiments of the invention, some or all of the hydrophobic groups of each of the plurality of cyclic molecules include a. group that enhances or increases miscibility of the polyrotaxane to the thermoplastic polymer. Thus, the miscibility of such polyrotaxane to the thermoplastic polymer is enhanced or increased compared to the miscibility of the polyrotaxane that does not include the group that enhances or increases miscibility of the polyrotaxane to the thermoplastic polymer. The miscibility of the polyrotaxane in the thermoplastic polymer can be measured as Hildebrand solubility parameter (δ or simply referred to as SP). δ is square root of the cohesive energy density and can be represented as:

δ=(E/V)^{1/2}

wherein E is molar cohesive energy (cal) and V is molar volume (cm³/mol).

The location of the group that enhances miscibility of the polyrotaxane to the thermoplastic polymer is not particularly limited but preferably it is bound to the end of the hydrophobic group. In some embodiments, the group that enhances miscibility of the polyrotaxane to the thermoplastic polymer is a monomer of the thermoplastic polymer. After the monomer is bound to the hydrophobic group, a monomer unit derived from the monomer exists in the hydrophobic group. Thus, the group can be selected appropriately depending on the kind of the thermoplastic polymer and those skilled in the art can bind the group to the thermoplastic polymer by a known method in the art such as esterification of hydroxy of the hydrophobic group with an acid and substitution of a hydrophobic radical of the hydrophobic group with the monomer of the thermoplastic polymer. For example, When the thermoplastic plastic polymer is PMMA, the group that enhances miscibility may be methacryloyl and acryloyl. When the thermoplastic plastic polymer is polycarbonate the group that enhances miscibility may be a carbonate group. When the thermoplastic plastic polymer is polyester, the group that enhances miscibility may be an ester group such as an alkyl ester or an carboxylai.e ester. When the thermoplastic plastic polymer is polyethylene terephthalate), the group that enhances miscibility may be a terephthalate group, When the thermoplastic plastic polymer is poly style. e, the group that enhances miscibility may be a styrene group.

The degree of modification of hydroxy groups of the cyclic molecules with the hydrophobic group is not particularly limited but preferably not less than 20%, more preferably not less than 30%, more preferably not less than 40% of the hydroxyl groups out of the total number of the hydroxyl groups of the plurality of cyclic molecules are substituted with a hydrophobic group.

The degree of the group that enhances miscibility of the polyrotaxane to the thermoplastic polymer is not particularly limited but, for example, not less than 20%, more preferably not less than 30%, more preferably not less than 40%, more preferably not less than 50% of the hydroxyl groups out of the total number of the hydrophobic groups of the plurality of cyclic molecules have the group that enhances miscibility, preferably at the end of each hydrophobic group.

In some embodiments of the invention, the polyrotaxane partially couples or reacts with thermoplastic polymer to form new bonds between the polyrotaxane and the thermoplastic polymer. The bonds include covalent bonds, hydrogen bonding, ionic bonding, or frictional interaction, Without wishing to be bound by any theory, it is believed that substitution of a hydroxy group of cyclic molecules with the hydrophobic group and further binding of the group that enhances miscibility of the polyrotaxane to the thermoplastic polymer contribute to improvement in scratch performance and fracture toughness in the composition. The inventors have discovered that methacrylate functionalized cycrodextrins in polyrotaxane have interacted with PMMA and caused PMMA molecules to exhibit significantly more damping when observed using DMA and dielectric spectroscopies. In contrast, cycrodexitrins that are not functionalized did not show molecular scale mobility coupling with PMMA. This indicates that the methacrylate functionalized cycrodextrins in polyrotaxane have interacted with RNBIA and caused PM IMA molecules to exhibit significantly more damping when observed using DMA and dielectric spectroscopies. The partial interaction of functionalized polyrotaxane with PMMA or other polymer matrices may lead to complete miscibility or phase separation described below depending on the amount and type of functional group introduced on cycrodexttin. Such inter-molecular interaction between functionalized polyrotaxane and polymer matrix is the key to greatly improved properties of the composition.

Polyrotaxanes including a plurality of cyclic molecules and a chain polymer passing through the plurality of the cyclic molecules in a skewering manner and in which a whole of or a part of the hydroxyl groups of the plurality of cyclic molecules are substituted with a hydrophobic group and a group that enhances miscibility of the polyrotaxane to the thermoplastic polymer is bound to a whole or a part of the hydrophobic groups of each of the plurality of cyclic molecule are available from Advanced Softmaterials Inc. or may be manufactured by a method as disclosed in Jun Araki, et al. Soft Matters, 4, 245-.249(2008) by grafting lactone to the cyclodextrin of the polyrotaxane and substituting the hydroxy groups in the lactone with a hydrophobic group.

Optionally, in terms of enhancing reactivity with the thermoplastic polymer, all or a part of the hydrophobic groups may have a functional group. When a crosslinking agent is not used, such functional group may be varied as appropriate depending on a solvent to be used. On the other hand, when a crosslinking agent is used, such functional group may be varied depending on the crosslinking agent to be used. Examples of the functional groups may include, but are not limited to, a hydroxy group, a carboxylic group, an amino group, an epoxy group, an isocyanate group, a thiol group, an aldehyde group and the like.

In some embodiments, the hydrophobic group of the cyclic molecules does not have a functional group that is reactive to the thermoplastic polymer other than the group that enhances miscibility of the polyrotaxane to the thermoplastic polymer, and the thermoplastic polymer and the cyclic molecule in the composition are substantially not crosslinked. That is, in some embodiments, more than 95% of the thermoplastic polymer out of the total number of the thermoplastic polymer in the composition are not crosslinked with polyrotaxane. In other embodiments, more than 98% of the thermoplastic polymer out of the total number of the thermoplastic polymer in the composition are not crosslinked with polyrotaxane. In further embodiments, 100% of the thermoplastic polymer out of the total number of the thermoplastic polymer in the composition are not crosslinked with polyrotaxane. Even such compositions are excellent in toughness and/or scratch resistance.

Polyrotaxanes can be prepared using a wide variety of the chain polymers and the cyclic molecules as described above. References that describe suitable polyrotaxanes are J. Araki et al., Soft Matter 2007, 3, 1456-1473; (i Wenz, et al.., Chem. Rev., 2006, 106, 782-817 and A. Harada et al, Chem. Rev., 109, 5974-6023, for example.

Generally speaking, polyrotaxanes are prepared by mixing one or more chain polymer with cyclic molecules. In time the cyclic molecules thread onto each of the chain polymers like rings on a string to form polyrotaxanes. Capping chemistry is used to prevent the chain polymers from disentangling with the cyclic molecules. For example, polyethylene glycol and cyclodextrin are mixed. An equilibrium concentration of entangled and nun-entangled linear chains forms. The hydroxyl end-groups of the polyethylene glycol are then esterified with bulky acids such as dinitrobenzoate, 1,1,1-triphenylaceta.te, and adamantyl ca boxylate. This capping process prevents the chain polymer from disentangling with the cyclic molecules,

The product of this chemistry is a mixture of polyrotaxanes and non-entangled chain polymers and cyclic molecules. The polyrotaxanes can be isolated by standard methods such as selective precipitation. However, impure mixtures are also claimed. This synthetic approach is versatile, and polyrotaxanes can be formed with chain polymers with a variety of molecular weights and composition, including copolymers. The chain polymer can be entangled (inserted into) more than one cyclic molecule.

Particularly, polyrotaxanes prepared with polyethers as the linear molecule and cyclodextrins as the ring molecule are attractive in that they are inexpensive, a widely available in a number of variants, and form polyrotaxanes with good efficiency. Such polyrotaxanes are described in U.S. Pat. No. 6,828,378, for example.

In some embodiments of the composition of the present invention, the polyrotaxane is not completely soluble in the thermoplastic polymer. As a consequence, at least a portion of the polyrotaxane exists in a separate phase that can be observed using microscopy. For example, transmission electron microscopy (TEM) can be used to reveal polyrotaxane phases, typically Sum or smaller across, surrounded by the thermoplastic matrix. In some embodiments, polyrotaxane phases/particles are around 100-200 nm in their size.

Surprisingly, a unique structure is observed for the composition including a thermoplastic polymer and a polyrotaxa.ne of the present disclosure in the field of view of 5×5 μm² by transmission electron microscopy due to the modification of all or a part of the hydroxy groups of the plurality of cyclic molecules in the polyrotaxane with a hydrophobic group and introduction of the group that enhances or increases miscibility of the polyrotaxane to the thermoplastic polymer into the hydrophobic group. Specifically, the composition including a thermoplastic polymer and a polyrotaxane of the present disclosure has the structure in which a plurality of discontinuous phases of particles containing the polyrotaxane are present in a continuous phase of the thermoplastic polymer and a part of or a whole of the plurality of discontinuous phases have the structure in which particles of the polyrotaxane are dispersed in the thermoplastic polymer. This structure is a multiphase structure in which particles of the polyrotaxane are dispersed in the thermoplastic polymer and can be observed at least in the state of 20 ° C. and 1 atm. This multiphase means that the polyrotaxane is not completely dissolved in the thermoplastic polymer. The term “not completely dissolved” can be used interchangeably with “not completely soluble.” As used herein, the term “not completely soluble” refers to the state where a thermoplastic polymer and a polyrotaxane are at least partially observed as separate phases at 20°C. and 1 atm when observed with a transmission electron microscope.

In contrast, for the composition in which hydroxy groups of the cyclic molecules of the polyrotaxane are not modified with a hydrophobic group, polyrotaxane is soluble in the thermoplastic polymer. Thus, the above unique structure is not observed.

We postulate that this multiphase structure is important for the observed improvements in toughness and/or scratch resistance. Also, because the polyrotaxane does not dissolve in the thermoplastic polymer, no noticeable glass transition temperature drop of the thermoplastic is observed (DMA plots). This is important because the properties of thermoplastics change dramatically about the glass transition temperature. High glass transition temperatures are often desirable for engineering applications.

When the polyrotaxane in which a whole of or a part of the hydroxyl groups of the plurality of cyclic molecules are substituted with a hydrophobic group and the group that enhances or increases miscibility of the polyrotaxane to the thermoplastic polymer is bound to the hydrophobic group is mixed with the thermoplastic polymer, toughness and/or the scratch resistance of the composition are improved compared to the neat thermoplastic polymer, a composition comprising a thermoplastic polymer and a polyrotaxane in which polyrotaxane including cyclic molecules having hydroxy groups that are not modified with a hydrophobic group and a composition comprising a thermoplastic polymer and a polyrotaxane in which the polyrotaxane including cyclic molecules having hydroxy groups some or all of which are modified with a hydrophobic group but the group that enhances or increases miscibility of the polyrotaxane to the thermoplastic polymer is not bound to the hydrophobic group.

Surprisingly, this multiphase structure does not significantly reduce the optical clarity of the composition. This may be due to a similarity of the refractive index between the polyrotaxane and the thermoplastic polymer or size of the insoluble polyrotaxane domains is smaller than the wavelength of light.

The amount of the polyrotaxane in the composition is not particularly limited in terms of retaining the property of the thermoplastic polymer and improving toughness and/or scratch resistance, it is preferably 10 mass % or less. In one embodiment, the amount of the polyrotaxane in the composition is from 0.1 mass % to 5 mass %. In another embodiment, the amount of the polyrotaxane in the composition is from 0.5 mass % to 5 mass %.

In addition to the thermoplastic polymer and the polyrotaxane, known additives may be added to the composition of the present disclosure as long as they do not inhibit an effect of the invention. Such additives may include, but are not limited to, an antioxidant for preventing color change or yellowing, a UV absorbing agent for improving weather resistance, a chain transfer agent for controlling molecular weight, a flame retardant for providing flame retardancy, a colorant and the like.

In preferred embodiments, the polyrotaxane is derived from polyethylene glycol and cyclodextrin in which a portion of the hydroxyl groups are substituted, and the thermoplastic polymer includes or is polymethylmethacrylate (PM SIA) Polyacrvlates such as PMMA are used in applications such as automotive lenses, electronic displays, and window glazing where optical clarity and toughness are desirable, In these applications, materials are exposed to abrasive action that can leave permanent visible damage. Polyrotaxanes as additives act to improve toughness and/or scratch resistance without degrading other properties, especially optical transparency.

A composition of an embodiment of the invention is excellent in scratch resistance. Scratch resistance can be assessed by known tests for measuring scratch resistance of a polymer composition. In one embodiment, the load of crack formation of the composition having a thickness of 1 mm is 80 N or more when measured with a 1 mm scratch tip in accordance with the ASTM D7023-13/ISO19252:2008.

A composition of an embodiment of the invention is excellent in optical property. In one embodiment, the composition has a light transmittance of not less than 85% at a wavelength of ranging from 400 to 700 nm at a 1 mm film thickness. This embodiment exhibits excellent transparency in the visible region.

A composition of an embodiment of the invention is excellent in fracture toughness. In one embodiment, the mode I critical stress intensity (K_{IC}) of the composition is 1.5 MPa.m^{1/2} or higher in single-edge-notch three-point-bending (SEN-3PB) test. Kic of the composition is more preferably 2.0 MPa.m^{1/2} or higher. The thermoplastic polymer in the composition includes, but is not limited to, polymethacrylate, polycarbonate, polyester, polyethylene terephthalate), polystyrene or a combination thereof. The thermoplastic polymer is preferably PMMA.

A method for producing a composition comprising a thermoplastic polymer and a polyrotaxane comprises providing a polyrotaxane and blending a thermoplastic polymer and the polyrotaxane. The polyrotaxane includes a plurality of cyclic molecules and a chain polymer passing through the plurality of the cyclic molecules in a skewering manner. At least a part of the hydroxyl groups of each of the plurality of cyclic molecules are substituted with a hydrophobic group. A group that enhances miscibility of the polyrotaxane to the thermoplastic polymer is bound to at least a part of the hydrophobic groups of each of the plurality of cyclic molecules.

The mixing step may be performed with a conventional mixing device such as a mixer and an extruder.

In some embodiments, more than 20% of the hydroxyl groups out of the total number of the hydroxyl groups of the plurality of cyclic molecules are substituted with a hydrophobi group. In some embodiments, the mixing step of the thermoplastic polymer and the polyrotaxane includes melt-mixing the thermoplastic polymer and the polyrotaxane. After that, the melt is cooled to obtain a composition of the invention.

In some embodiments, the mixing step of the thermoplastic polymer and the polyrotaxane includes mixing the thermoplastic polymer and the polyrotaxane in a solvent. The mixing of the thermoplastic polymer and the polyrotaxane in a solvent may include dissolving the polyrotaxane in a solvent and mixing the solvent containing the polyrotaxane with the thermoplastic polymer or a solution in which the thermoplastic polymer is dissolved in another solvent. The solvent in which the polyrotaxane is dissolved and the solvent in which the thermoplastic polymer is dissolved may be the same or different. Preferably, the two solvents are the same. Such solvent may include, but is not limited to, tetrahydrofuran, chloroform, acetone, methyl ethyl ketone, methylene chloride, and the like.

After the mixing step, a solvent is removed to obtain a solid material of the composition of the invention. The method of removing a solvent may include drying with a heating device such as an oven and drying under reduced pressure. The solid material can be fabricated into one or more finished products.

In some embodiments, the method further comprises molding the blend of the thermoplastic polymer and the polyrotaxane after the blending step. The molding includes press molding, extrusion molding, injection molding and the like. The composition is processed by the molding and a molded article of any shape such as a film a sheet may be obtained. As used, herein, a film refers to a thin film having a thickness of less than 250 μm. A sheet refers to a plate having a thickness of 250 μm or more.

It is also possible to perform the melt-mixing process during the fabrication of the one or more finished products. The polyrotaxane (e,g., about 0.1 to 5 wt. %) and the thermoplastic polymer would be combined during injection molding or die-extrusion operation to fabricate finished parts. Although this adds some complexity to the injection molding process, it has the advantage of avoided a separate mixing process.

Notwithstanding the appended claims, aspects of the present invention and exemplary embodiments are described by the following clauses:

Item 1. A composition comprising a thermoplastic polymer and a polyrotaxane, the polyrotaxane including a plurality of cyclic molecules and a chain polymer passing through the plurality of the cyclic molecules in a skewering manner, at least a part of the hydroxyl groups of the plurality of cyclic molecules being substituted with a hydrophobic group, a group that enhances miscibility of the polyrotaxane to the thermoplastic polymer being bound to at least a part of the hydrophobic groups of each of the plurality of cyclic molecules.

Item 2. The composition of Item 1, wherein the polyrotaxane couples with the thermoplastic polymer.

Item 3. The composition of Item 1, wherein the composition has the structure in which a plurality of discontinuous phases of particles containing the polyrotaxane are present in a continuous phase of the thermoplastic polymer and a part of or a whole of the plurality of discontinuous phrases have the structure in which particles of the polyrotaxane are dispersed in the thermoplastic polymer, in the field of view of 5×5 um² by transmission electron microscopy.

Item 4. The composition of any one of Items 1 to 3 wherein more than 20% of the hydroxyl groups out of the total number of the hydroxyl groups of the plurality of cyclic molecules are substituted with a hydrophobic group.

Item 5. The composition of any one of Items 1 to 4, wherein the chain polymer passing through the plurality of the cyclic molecules in a skewered manner has the weight average molecular weight of 20,000 or less.

Item 6. The composition of any one of Items 1 to 5, wherein more than 95% of the thermoplastic polymer out of the total number of the thermoplastic polymer in the composition are not crosslinked with polyrotaxane.

Item 7. The composition of any one of Items 1 to 6, wherein 95% or more of the thermoplastic polymer out of the total number of the thermoplastic polymer in the composition is not polymerized each other.

Item 8. The composition of any one of Items 1 to 7, wherein the composition includes 10 wt. % or less of the polyrotaxane.

Item 9. The composition of any one of Items 1 to8, wherein the thermoplastic polymer includes potymethacryl ate, polycarbonate, polyester, poly(ethylene terephthalate), polystyrene or a combination thereof

Item 10. The composition of any one of claims 1 to 8, wherein the thermoplastic polymer includes polymethyl methacrylate, polypropylene, or polyethylene terephthalate).

Item 11. The composition of any one of Items 1 to 10, wherein the cyclic molecules include cyclodextrin.

Item 12. The composition of any one of Items 1 to 11, wherein the hydrophobic group includes a polyester, alkyl, polyether, or unsaturated hydrocarbon.

Item 13. The composition of any one of claims 1 to 12, wherein the group that enhances miscibility of the polyrotaxane to the thermoplastic polymer includes a monomer or a partial constituent of the thermoplastic polymer.

Item 14. The composition of any one of claims 1 to 12, wherein thermoplastic polymer includes PMMA and the group that enhances miscibility of the polyrotaxane to the thermoplastic polymer includes a methaciyloyl group or an actyloyl group.

Item 15. The composition of any one of Items 1 to 14, wherein the crack onset load of the composition having a thickness of 1 mm is 80 N or more when measured with a 1 mm scratch tip in accordance with the ASTM D7023-13/ISO19252:2008 scratch test.

Item 16, The composition of any one of Items 1 to 15, wherein the mode I critical stress intensity (K_{IC}) of the composition is 1.5 MPa.m^{1/2} or higher in single-edge-notch three-point-bending (SEN-3PB) test.

Item 17. The composition of any one of Items 1 to 16, wherein the composition has light transmittance of not less than 85% at a wavelength of ranging from 400 to 700 nm at a 1 mm film thickness.

Item 18, A molded article comprising the composition of any one of Items 1 to 17.

Item 19, A film comprising the composition of any one of Items 1 to 17.

Item 20. A method of producing a composition comprising a thermoplastic polymer and a polyrotaxane, the method comprising providing a polyrotaxane, the polyrotaxane including a plurality of cyclic molecules and a chain polymer passing through the plurality of the cyclic molecules in a. skewering manner, at least a part of the hydroxyl groups of each of the plurality of cyclic molecules being substituted with a hydrophobic group, a group that enhances miscibility of the polyrotaxane to the thermoplastic polymer being bound to at least a part of the hydrophobic groups of each of the plurality of cyclic molecules; and blending a thermoplastic polymer and the polyrotaxane.

Item 21. The method of Item 20, wherein the blending includes melting the thermoplastic polymer and the polyrotaxane.

Item 22. The method of Item 20, wherein the blending includes blending the thermoplastic polymer and the polyrotaxane in a solvent and the method further comprises removing the solvent after the blending step.

Item 23. The method of any one of claims 20 to 21, further comprising molding the blend of the thermoplastic polymer and the polyrotaxane after the blending step.

### EXAMPLES

### Example 1

The objective of these experiments is to determine the effect of polyrotaxane on scratch resistance of polymers.

### 1. Preparation of Samples

A series of 16 films were prepared using the following methods. Polymethylmethacrylate (PMMA, MW-120,000) in powder form was purchased from Sigma-Aldrich. Polyrotaxane, (SM1303P from Advanced Softmaterials Inc.) is a polyrotaxane derived from difunctional polyethylene glycol capped with adamantyl groups on each end and encircled with cyclodextrin, approximately half of the hydroxy of polycaprolactone graft-polymerized to the cyclodextrin is methylated due to the reaction with methacrylic acid.

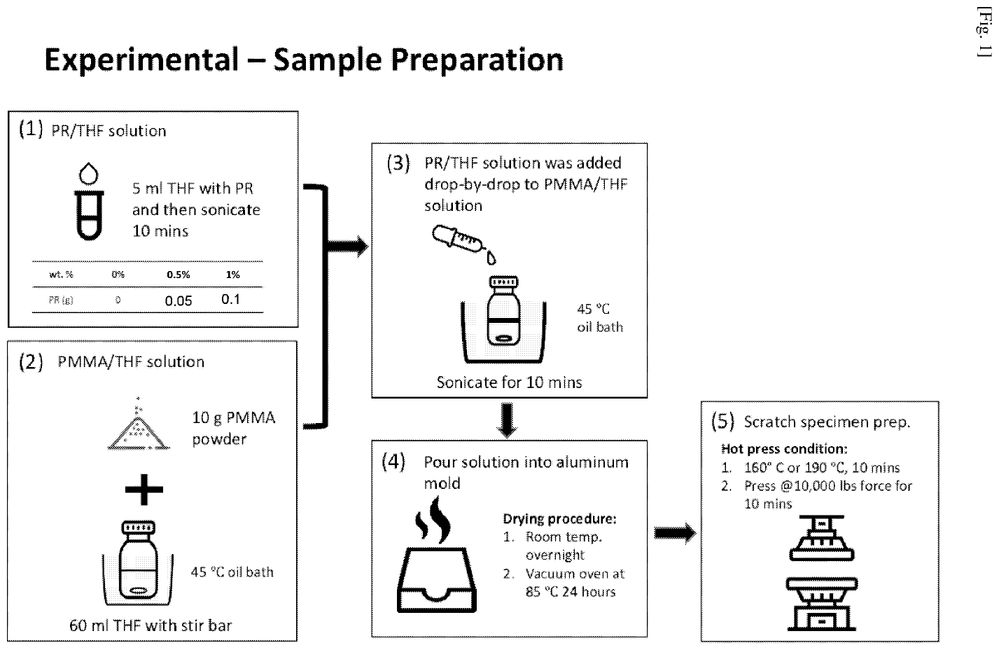

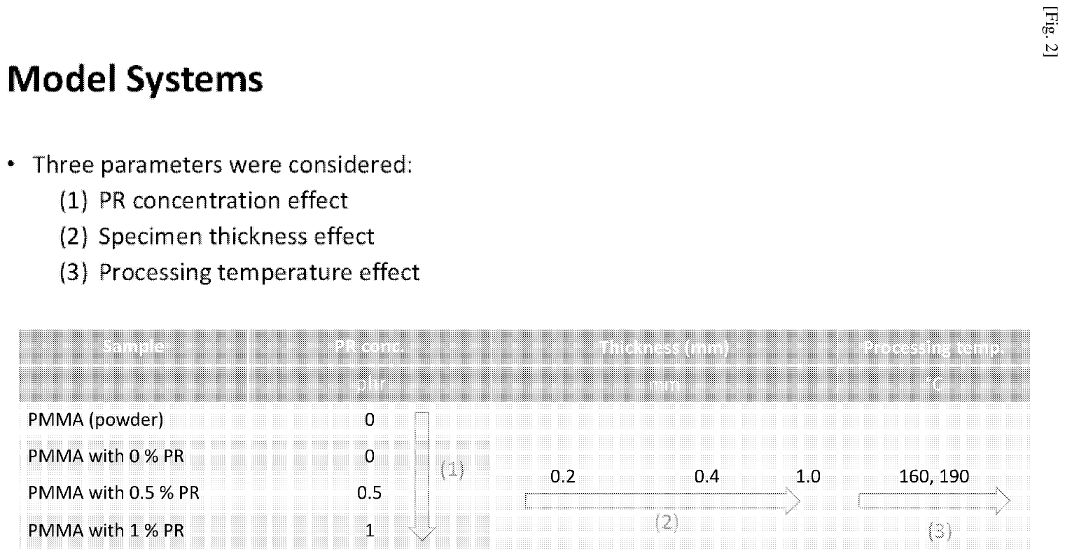

As illustrated in FIG. 1, 0.05 g of polyrotaxane (PR) was dissolved in 5 mL tetrah.ydrofuran (THE) using sonication. This solution was added dropwise to a solution of 10 g polymethylmethacrylate (PUMA) in 60 mL with sonification and oil bath heating (45° C.). After 10 minutes, the solution was poured into an aluminum foil mold, and the solvent was evaporated in a vacuum oven at 85° C. for 24 hours. This sample contained 0.5 phr of PR and was labeled as PMMA_PR0.5%. Identical experiments were am using 0.1 g polyrota.xane,which contained 1 phr of PR and was labeled as PMMA_PR1%. A sample without polyrotaxane was prepared as a control system, labeled as PNIMA_PR0%.

The dried samples were formed into a film using a heated (at 160° C.) hydraulic press for 10 minutes. The final thickness of the film was 0.2 mm, 0.4 mm and 1.0 mm. The samples of no polyrotaxane, 0.05 g polyrotaxane and 0.1 g polyrotaxane are denoted as PMMA_0% PR, PMMA_0.5% PR and PMMA_1% PR, respectively. Films were also prepared with powdered PMMA, which is denoted as PMMA_powder. Finally, an additional set of 1 mm films was made by pressing at 190° C. Variations of the samples based on the concentration of PR, the final thickness of the film (mm) and press temperature (° C.) is illustrated in

2. Scratch Test in Accordance with ASTM D7027-1311S019252:2008

Instrumented scratch tests (3 for each film) were run on each film using the ASTM D7027-13/ISO19252:2008 procedure with a 1 mm spherical tip, linearly increasing load (1 to 150 N), a constant 10 mm/second speed, and a scratch length of 50 mm. After completion of scratch tests, the scratch deformation mechanism was observed using a laser confocal microscope under 10× magnification (Keyence VK9700 VLSCM).

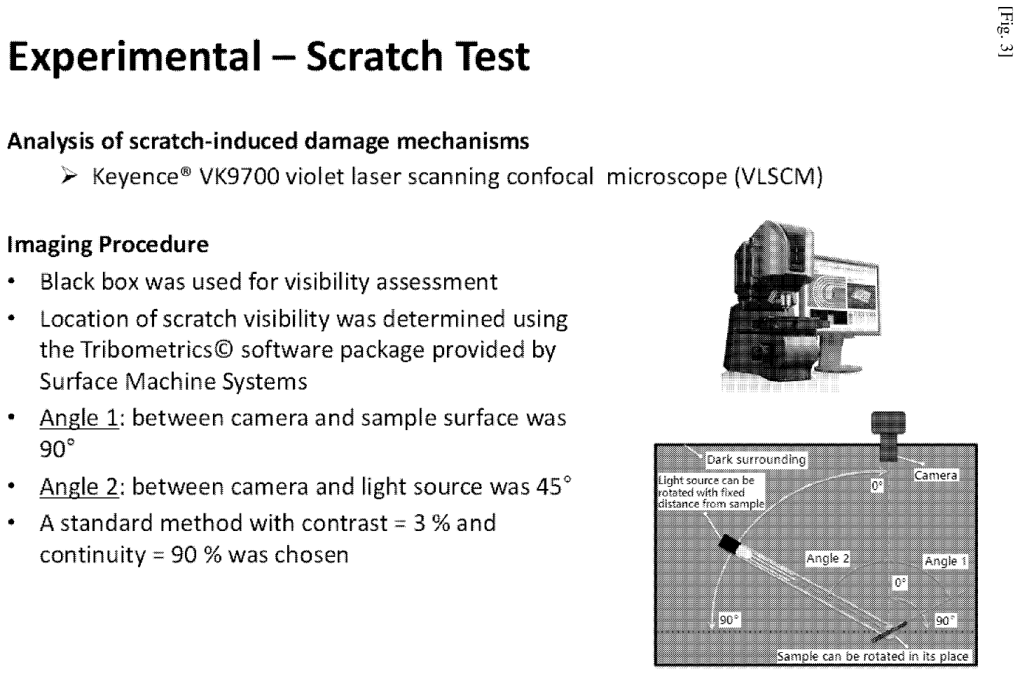

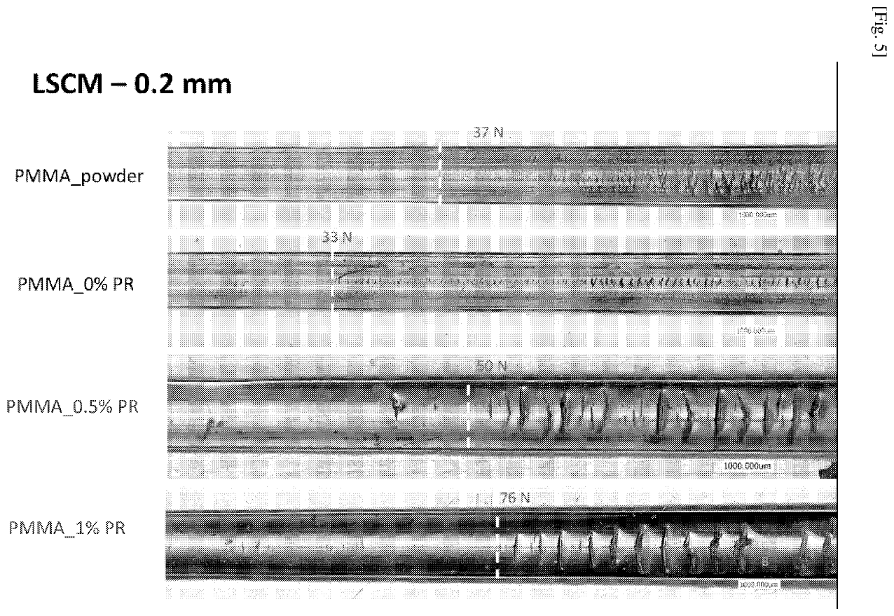

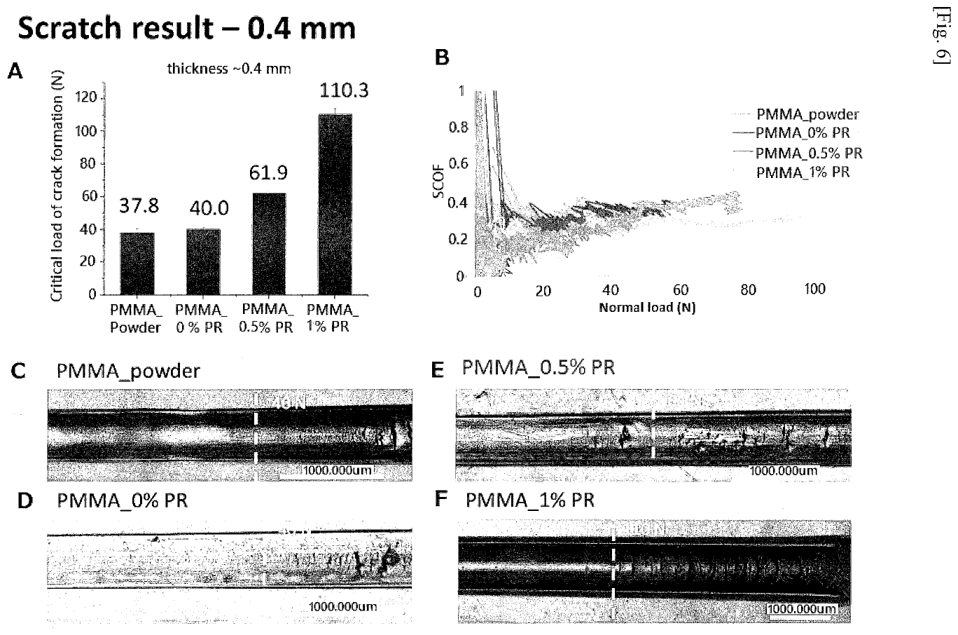

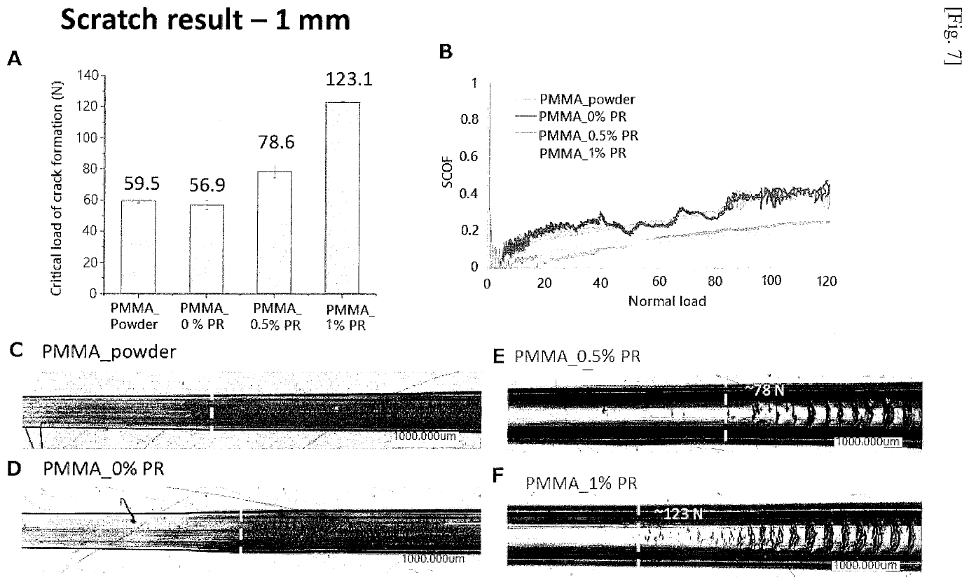

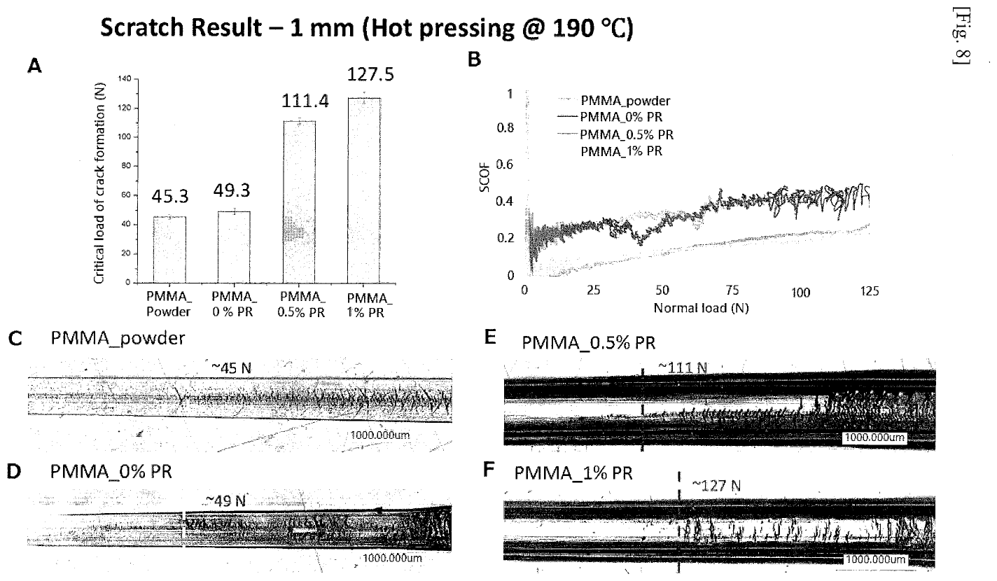

As illustrated in FIG. 3, critical load for crack formation was observed using VLSCM. The crack formation is continuous and tend to increase in periodicity with increasing load along the scratch path. Crack formation is characterized by a significant increase in surface roughness along the scratch track. The cracks may also be parabolic and point against the scratch direction. The examples for crack formation in PMMA and PMMA/PR composites with different thicknesses are shown in FIG. 5, FIG. 6C-F, FIG. 7C-F, FIG. 8C-F.

### Results

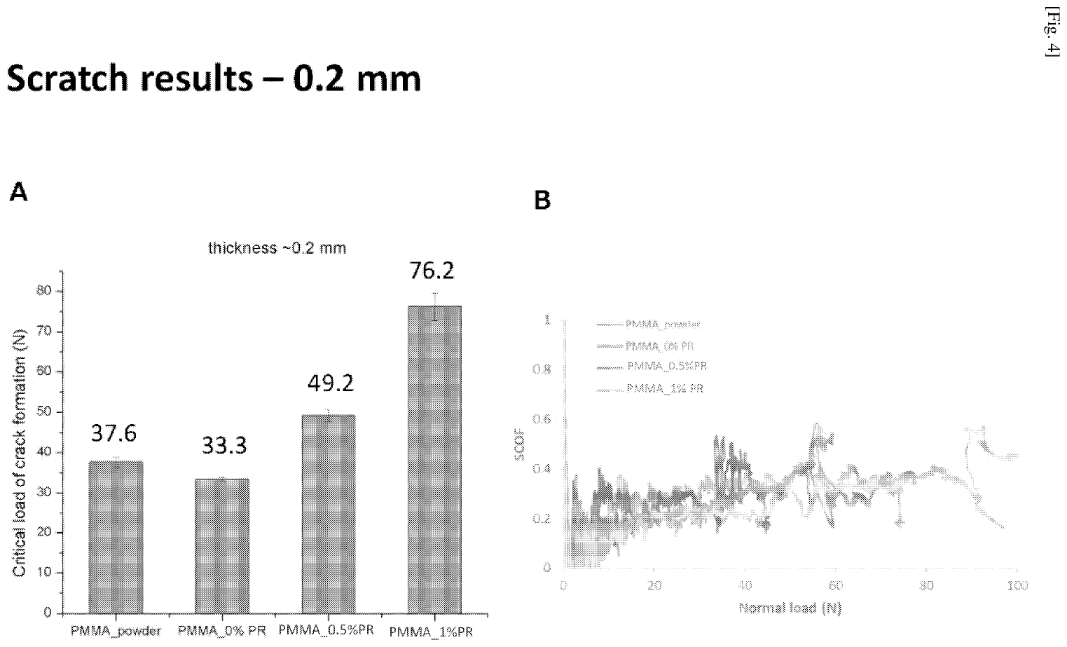

Table 1 and FIGS. 4 to 8 show the critical load for crack formation (N) in the scratch tests in accordance with ASTM D7027-13/ISO19252:2008. In the PMMA_PR0.5% and PMMA_PR1%, the critical load for crack formation increased compared to the powdered PMMA and the PMMA film that do not include polyrotaxane, regardless of the molding temperature and the concentration of polyrotaxane. When the molding temperature and the thickness of the films are the same, the critical load for crack formation was greater as the concentration of polyrotaxane was higher. When the molding temperature and the concentration of polyrotaxane are the same, the critical load for crack formation was greater as the thickness of the film was greater. When the thickness of the films and the concentration of polyrotaxane are the same, the critical load for crack formation was greater in the molding temperature of 190° C. than in the molding temperature of 160° C., but the difference in the critical load for crack formation due to the difference in the temperature of hot-press was not substantially observed in the PMMA_PR1%.

TABLE 1

| Molding | Thickness | Critical load of crack formation (N) | | | |
|---|---|---|---|---|---|
| temp (° C.) | (mm) | PMMA_powder | PMMA_0% PR | PMMA_0.5% PR | PMMA_1% PR |
| 160 | 0.2 | 37.6 ± 1.2 | 33.3 ± 0.5 | 49.2 ± 1.6 | 76.2 ± 3.4 |
| | 0.4 | 37.8 ± 2.5 | 40.0 ± 1.6 | 61.9 ± 1.0 | 110.3 ± 3.7 |
| | 1.0 | 59.5 ± 1.4 | 56.9 ± 2.9 | 78.6 ± 4.2 | 123.1 ± 0.6 |
| 190 | 1.0 | 45.3 ± 1.3 | 49.3 ± 2.1 | 111.4 ± 2.2 | 127.5 ± 4.1 |

### 3. Scratch Test for Scratch Visibility

As illustrated in 3, to examine the scratch visibility, each film was imaged in a black box to prevent samples being influenced from unwanted light source and was illuminated using a fluorescent light source. The images were captured using a high-solution camera (Canon ECUS REBEL T3i DSLR with EF-S 18-55mm zoom lenses). The angle between camera and sample surface was 45° and the angle between camera and sample surface was 90°. Captured images were analyzed using Tribometrics (Copyright) software package provided by surface Machine Systems. :A standard method with 3% contrast and 90?% continuity was chosen.

### Results

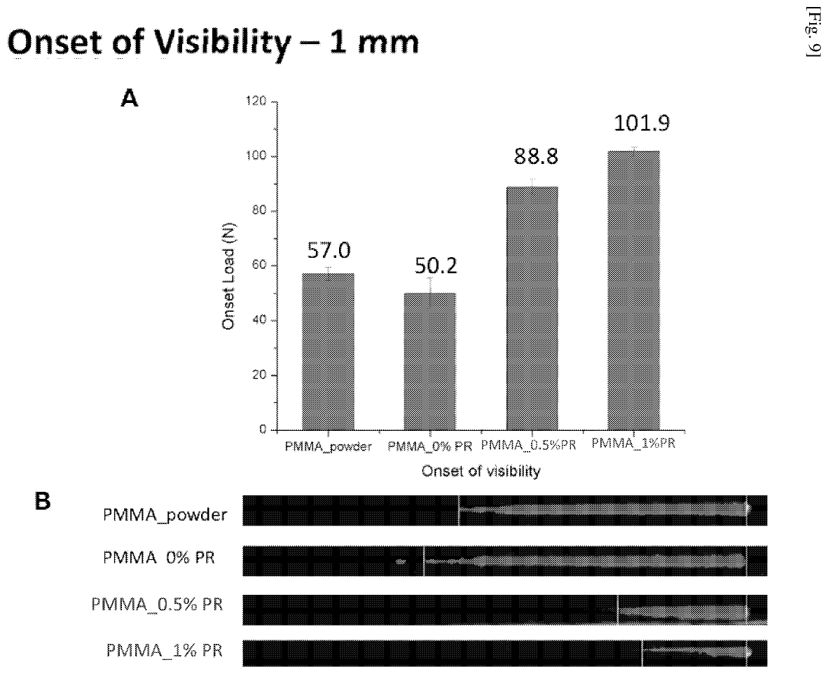

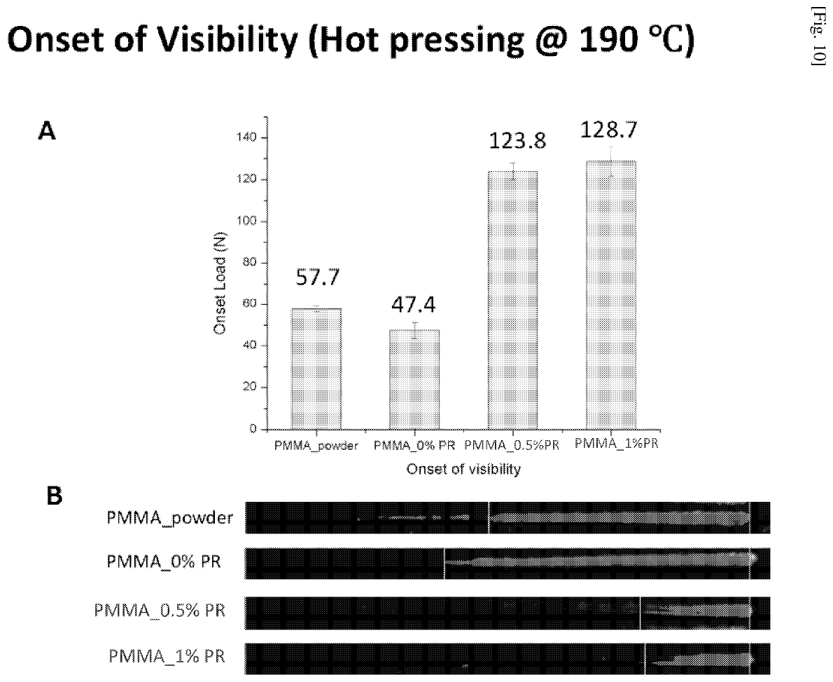

Table 2 and FIG. 9 show the onset load (N) of visible crack formation. In the PMMA film containing 0.5 phr polyrotaxane and the PN1MA film containing 1 phr polyrotaxane, the load of visible crack formation increased compared to the powder PMMA and the PMMA film that do not contain polyrotaxane regardless of the molding temperature and the concentration of PR. When the temperature is the same, the load of visible crack formation was greater as the concentration of polyrotaxane is higher. When the concentration of polyrotaxane is the same, the load of visible crack formation of the film that was molded at 190° C. was greater than that of the film molded at 160° C. (see FIG. 10).

TABLE 2

| Molding | Thickness | Onset of visibility (N) | | | |
|---|---|---|---|---|---|
| temp. (° C.) | (mm) | PMMA_powder | PMMA_0% PR | PMMA_0.5% PR | PMMA_1% PR |
| 160 | 1.0 | 57.0 ± 2.7 | 50.2 ± 5.5 | 88.8 ± 2.7 | 101.9 ± 1.7 |
| 190 | 1.0 | 57.7 ± 1.4 | 47.4 ± 3.8 | 123.8 ± 4.1 | 128.7 ± 7.0 |

### 4. Depth Analysis

The scratch depth of PMMA_Powder, PMMA_PR0%, PMMA_0.5% and PMMA_PR1%. PMMA_PR1% was measured by laser confocal microscopy (LCM). The specimens had a thickness of 0.2 mm and the depth was measured as a function of scratch normal load.

### Results

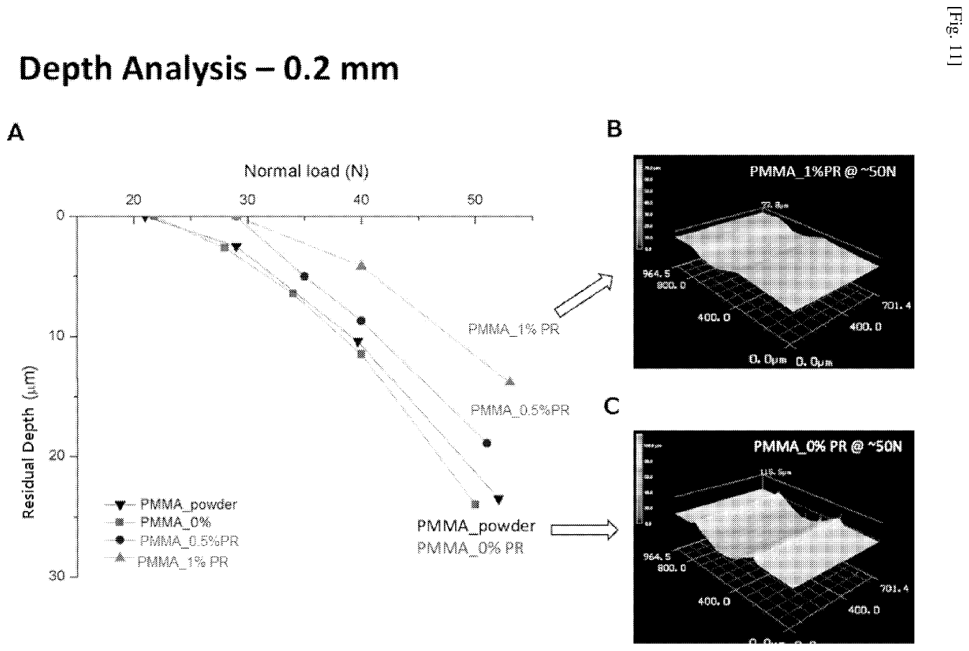

FIG. 11 (A) shows the post-scratch depth vs. scratch normal load of PMMA Powder, PMMA_PR0%, PMMA_0.5% and PMMA_PR1%. PMMA_PR1%. The PMMA film containing 1 phr of polyrotaxane exhibit a significant reduction in scratch depth in cornpaiison to the other systems. FIG. 11 (B-C) show a three-dimensional image of the surface profile at a normal load of 50 N for PMMA_PR1% (FIG. 11 (B)) and PMMA_PR0% (FIG. 11 (C)). The groove formation is severe in the PMMA film without polyrotaxane.

### 5. Measurement of Tensile Behavior

Young's modulus E (GPa), tensile strength a (MPa) and elongation at break ε (%) of each of PMMA_powder, PMMA_0% PR, PMMA_0.5° PR and PMMA_1% PR were measured. The films had a thickness of approximately 0.2 mm. The tensile tests were performed using a dynamic mechanical analyzer (RSA-G2). Young's modulus E was defined as the ratio between stress and strain in the linear region of the stress-strain curve. Tensile strength C5 was the stress at which failure occurred. The elongation at break F. was the strain at which failure occurred,

### Results

Tables 3 and 4 show the measured values of the samples molded at the temperature of 160° C. and 190° C. respectively. Young's modulus increased as the concentration of polyrotaxane increased. Elongation at break also increased with polyrotaxane concentration. Accordingly, not only the stiffness but also elongation at break of the sample films becomes greater as polyrotaxane is added. This may be responsible for the improvement in scratch resistance of the films.

TABLE 3

| | E | Tensile Strength | ε |
|---|---|---|---|
| | GPa | MPa | % |
| PMMA_Powder | 3.4 ± 0.2 | 54.4 ± 4.7 | 2.4 ± 0.4 |
| PMMA_0% PR | 3.5 ± 0.1 | 57.2 ± 3.5 | 2.5 ± 0.3 |
| PMMA_0.5% PR | 3.2 ± 0.1 | 60.7 ± 1.2 | 4.4 ± 0.9 |
| PMMA_1% PR | 3.6 ± 0.1 | 65.2 ± 2.5 | 4.0 ± 1.4 |

TABLE 4

| | E | Tensile Strength | ε |
|---|---|---|---|
| | GPa | MPa | % |
| PMMA_Powder | 3.5 ± 0.2 | 53.9 ± 2.3 | 2.2 ± 0.3 |
| PMMA_0% PR | 3.6 ± 0.2 | 51.4 ± 6.3 | 2.0 ± 0.5 |
| PMMA_0.5% PR | 3.3 ± 0.1 | 62.4 ± 3.7 | 3.4 ± 0.6 |
| PMMA_1% PR | 3.4 ± 0.1 | 60.0 ± 1.6 | 3.0 ± 0.2 |

### 6. Measurement of Glass Transition Temperature

Glass transition temperature of each of PMMA_powder, PMMA_0% PR, PMMA 0.5% PR and PMMA_1% PR was measured using dynamic mechanical analysis. The films were molded at 160° C. and had a thickness of 0.2-1 mm.

### Results

The glass transition temperatures of PMMA_powder, PMMA_0% PR, PMMA_0.5% PR and PMMA_1% PR molded at the molding temperature of 160° C. were 119° C., 121° C., 114° C. and 114° C., respectively. The grass transition temperatures of PMMA_0.5% PR and PMMA_1% PR decreased by approximately 5° C. compared to the film containing no polvrotaxane. The glass transition temperature of PMMA_powder, PMMA0% PR, PMMA_0.5% PR and PMMA_1% PR molded at the molding temperature of 190° C. were 124° C., 123° C., 126° C. and 124° C., respectively. The glass transition temperatures of PMMA_0,5% PR and PMMA_1% PR molded at 190° C. were higher than those of PMMA_0.5% PR and PMMA_1% PR molded at 160° C. by approximately 10° C. It is possible that the reason for this is that a part of polyrotaxanes react with each other in PMMA.

7. Light Transmittance of PMMA Films after Hot-Press

The optical transparency of the 1 mm thick PMMA films molded at 160° C. was investigated using an ultraviolet-visible spectrometer (Shimadzu, UV-3600) for visible wavelengths from 400-700 nm.

### Results

The percent light transmission for all samples raised from 85% at 400 nm to 90% at 700 nm with experimental error (data not shown).

### 8. Crosslinking and Molecular Weight of Polyrotaxane

Crosslinking: 200 μL of polyrotaxane in organic solution was dried at room temperature. Subsequently, it was dried in vacuum conditions at 140° C. for 12 hr. The obtained material and 200 μL of CHCl₃ were mixed.

Molecular Weight: 1 mg/mL of PMMA, PR, PMMA/PR samples were dissolved in 1 mL of CHCl₃. Size exclusion chromatography (SEC) using CHCl₃ as an eluent was carried out by using Shimadzu LC-10 AD and RID-10 with a calibration curve obtained using PEG standards purchases from Polymer Source, :Inc.

### Results

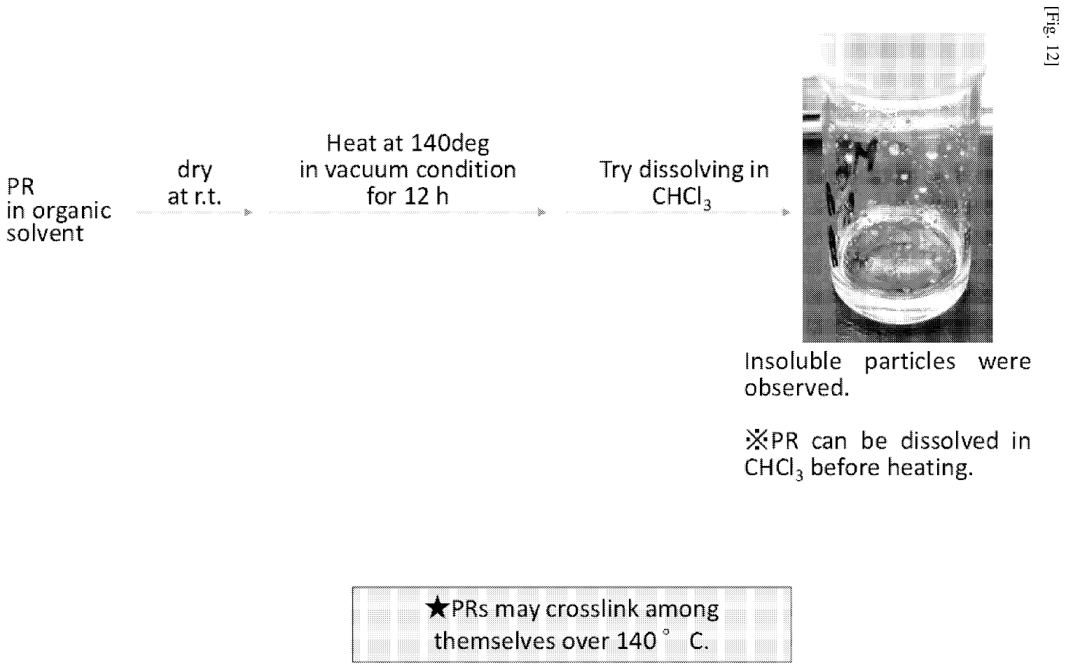

FIG. 12 shows a scheme of crosslinking reaction between polyrotaxanes. After heating polyrotaxane at 140° C. for 12 hr., the material did not dissolve in CHCl₃ and rendered insoluble particles (as shown in the picture). Polyrotaxane can be dissolved in CHCl₃ before heating. The results suggest that polyrotaxane may crosslink with itself when heated at or above 140° C.

The inventor also studied the effect of polyrotaxane on the molecular weight of PMMA after hot-pressing at different temperatures such as 165° C. and 190° C. Molecular weight did not change by processing at different temperatures. The results suggest that PMMA was not degraded even when pressing at 190° C. and that PMMA did not react with polyrotaxa.ne (data not shown).

### Example 2

### 1. Preparation of Samples

Polyrotaxane (0.1g, SM1303P from Advanced Softmaterials Inc.) was dissolved in 10 mL tetrahydrofuran (THF). The solution was added dropwise to a solution of 10 g polymethyl-methacrylate (PMMA) in 60 mL THF in oil bath heating at 50° C. and was stirred for 10-20 min. The mixture was sonicated for 15 min and was poured in an aluminum foil mold. The solvent was removed by placing in oven at 85° C. for at least 24 hr. This sample contained 1 phr polyrotaxane and was labeled as PMMA_mPR1%. The dried material was hot-pressed at 160° C. for 10-15 min. Polyrotaxane (0.1g, SH1300P from Advance Softmaterials ic) was prepared following the same procedure. This sample contained 1 phr polyrotaxane and was labeled as PMMA_uPR1%. 0.1g of cyclodextrin (CD) graft-polymerized with polycaprolactone was prepared following the same procedure. This system contained 1 phr of CD and was labeled as PMMA_CD1%. A sample without polyrotaxane or CD was prepared as a control system, labeled as Neat PMMA. The films had a thickness of approximately 0.2 mm.

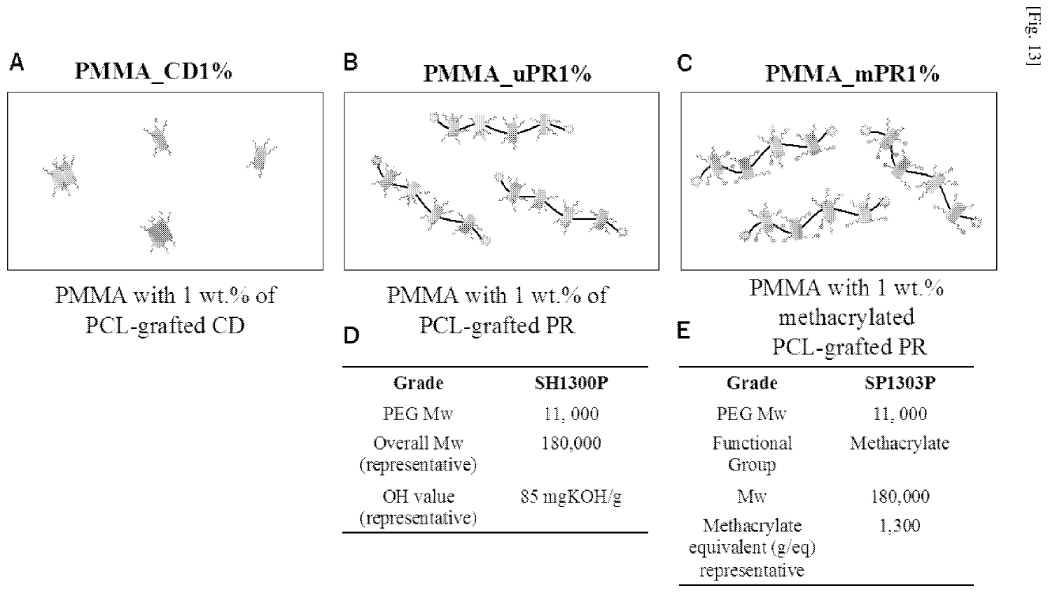

FIGS. 13A, 13B and 13C are schematic views of PMMA_CD1%, PMMA_uPR1% and PMMA_mPR1%, respectively. FIG. 13D is physical properties of SH1300P. FIG. 13E is physical properties of SP1303P.

### 2. Microscopic Observation of the Compositions

The morphology of the four samples PMMA_CD1%, PMMA_uPR1% and PMMA_mPR1% hot-pressed at 160° C., and PMMA_mPR1% hot-pressed at 190° C. was measured by transmission electron microscopy (TEM). The films were embedded in an epoxy mount, stained with O_{S}O₄ crystals for 6 hr., and rinse in water for 12 hr. The particle size and. distribution were measured using imageJ software. Because the polyrotaxane is not completely soluble in the thermoplastic, a portion or all of it exists as a separate phase that is stained differently from the th Tinopla.stic. This gives rise to the contrast observed in the images.

### Results

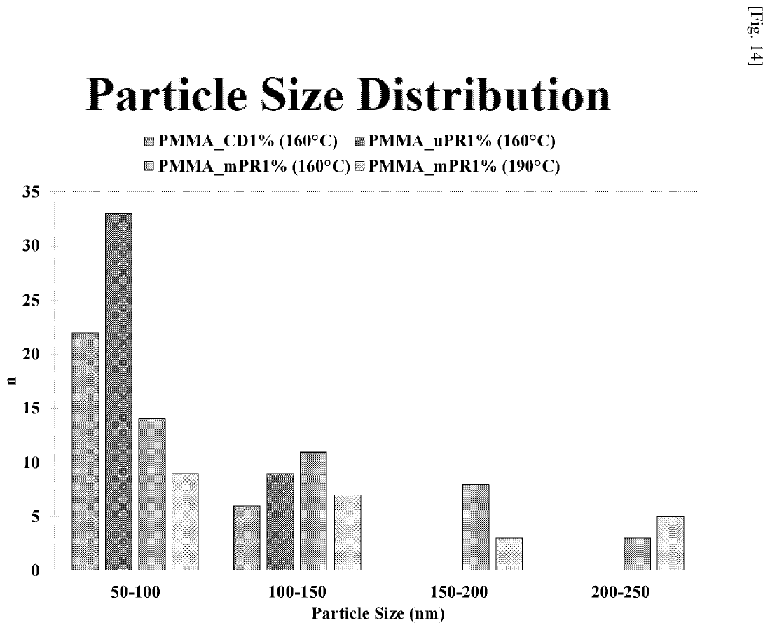

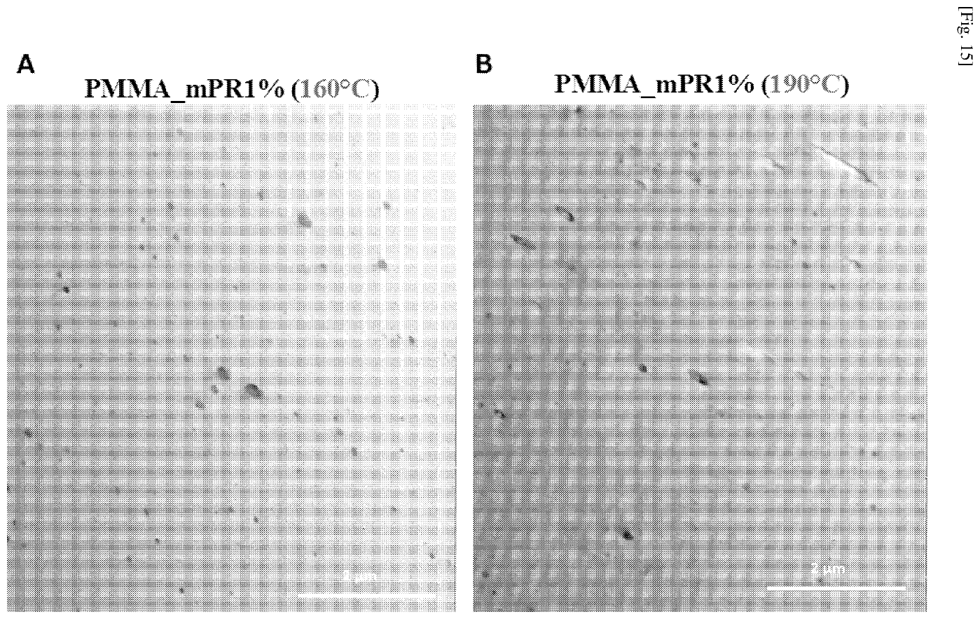

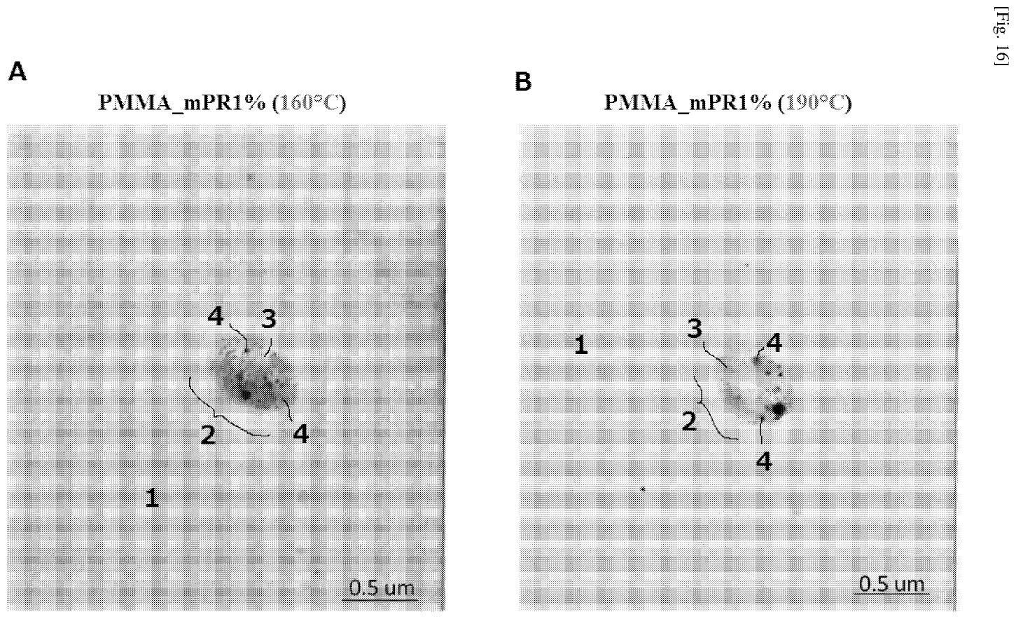

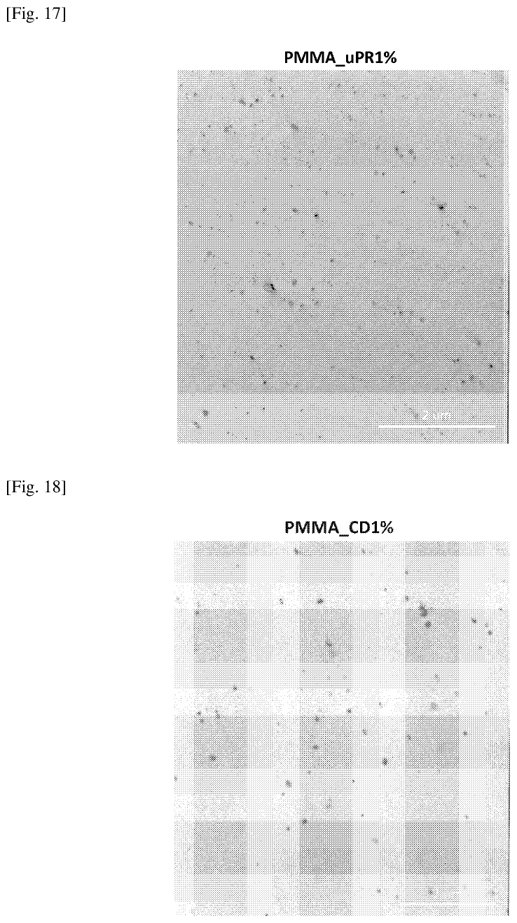

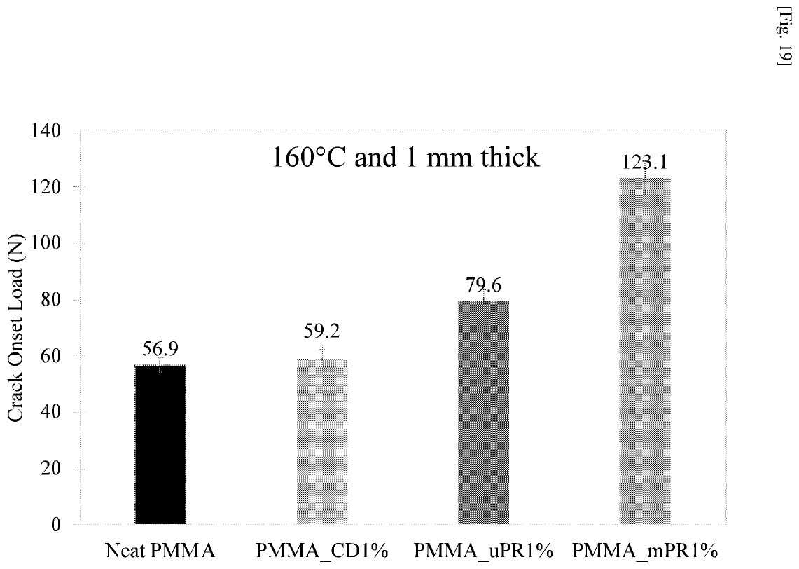

FIG. 14 shows the particle size and distribution of the four samples. FIG. 15 shows the morphology of PMMA_mPR1% pressed at 160° C. (A) and 190° C. (B). FIG. 16 is a high magnification TEM image of PMMA_mPR1% pressed at 160° C. (A) and 190° C. (B). FIG. 17 and FIG. 18 show a TEM images of PMMA_uPR1% and PMMA_CD1%, respectively.

In FIG. 15A-B, a plurality of discontinuous phases of particles containing the polyrotaxane are observed as dark spots in a continuous phase of PMMA. At higher magnification, as shown in FIG. 16A-B, the discontinuous phases (2) is present in the continuous phase of PMMA (1) and a has the structure in which particles of the polyrotaxane (4) are dispersed in PMMA (3). This unique structure was not observed in the PMMA_uPR1% film (FIG. 17) or the PMMA_CD1% film (FIG. 18).

3. Scratch Test in Accordance with ASTM D7027-13/ISO19252:2008

The scratch resistance was examined on the Neat PMMA, PMMA_CD1%, PMMA_uPR1% and PMMA_mPR1% hot-pressed at 160° C. using the same method in Test example 1 section 2.

### Results

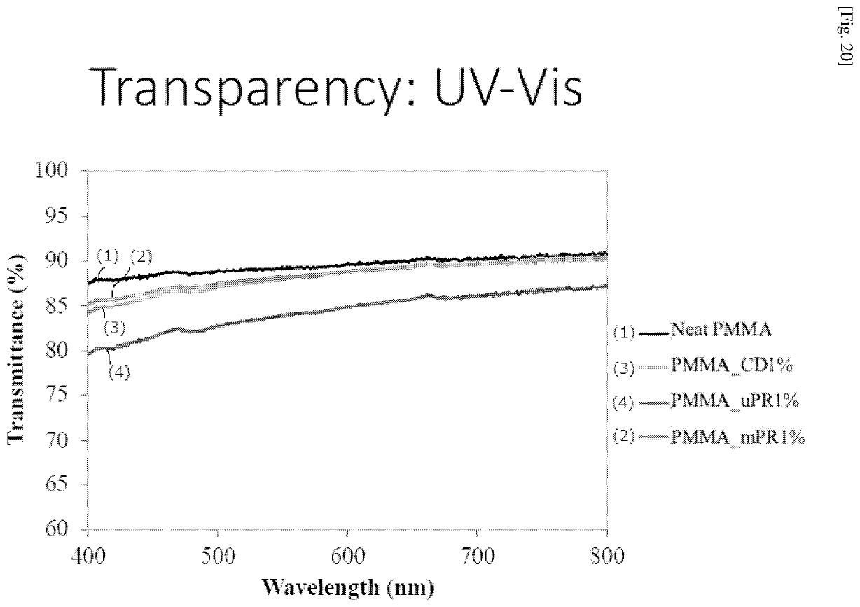

FIG. 19 shows the onset load (N) of crack formation. In the PMMA_uPR1% and PMMA_mPR1%, both of which contain polyrotaxane, the load of visible crack formation increased compared to the Neat PMMA and the PMMA_CD1% that do not contain polyrotaxane. The load of crack formation was greater in the PMMA_mPR1% than in the PMMA-uPR1%. This indicates that substitution of hydroxyl groups of CDs with a hydrophobic group and binding of a group that enhances miscibility of the polyrotaxane to the thermoplastic polymer to the hydrophobic group have an effect on increase in the resistance against crack formation during scratching.

### 43 Measurement of Tensile Behavior

The tensile tests were performed using a dynamic mechanical analyzer (RSA-G2). Young's modulus E was defined as the ratio between stress and strain in the linear region of the stress-strain curve. Tensile strength σ was the stress at which failure occurred. The elongation at break c was the strain at which failure occurred.

### Results

Table 5 shows the tensile strength, elongation at break and modulus of Neat PMMA, PMMA_CD1%, PMMA_uPR1% and PMMA_mPR1%, The tensile modulus of PMMA_CD1% slightly decreased in comparison to Neat PkIMA. Neat PMMA, PMMA_uPR1% and PMMA_mPR1% have a similar tensile modulus. The tensile strength and elongation at break increase in of both PMMA_mPR1% and PMMA_uPR1%.

TABLE 5

| | Tensile | Elongation | Tensile |
|---|---|---|---|
| | Strength (MPa) | at Break (%) | Modulus (GPa) |
| Neat PMMA | 57.2 ± 3 | 2.5 ± 0.3 | 3.5 ± 0.1 |
| PMMA_CD1% | 58.3 ± 4 | 2.2 ± 0.1 | 3.1 ± 0.2 |
| PMMA_uPR1% | 77.7 ± 6 | 3.1 ± 0.2 | 3.5 ± 0.3 |
| PMMA_mPR1% | 65.2 ± 2 | 4.0 ± 1.0 | 3.6 ± 0.1 |

### 5. Compressive Strength:

Polyrotaxane (0.05g, SM1303P from Advanced Softmaterials Inc.) was dissolved in 10 ml. tetrahydrofuran min. The solution was added dropwise to a solution of 5 g polymethyl-methacrylate (PMMA) in 60 mL THF in oil bath heating at 50° C. and was stirred for 10-20 min. The mixture was sonicated for 15 min and was poured in an aluminum foil mold. The solvent was removed by placing in oven at 85° C. for at least 24 hr. This sample contained 1 phr polyrotaxane and was labeled as PMMA_mPR1%. Polyrotaxane (0.05g, SH1300P from Advance Softmaterials Inc) was prepared following the same procedure. This sample contained 1 phr poly rotaxane and was labeled as PMMA_uPR1%. 0.05g of cyclodexttin (CD) graft-polymerized with polycaprolactone was prepared following the same procedure, This system contained 1 phr of CD and was labeled as PMMA_CD1%. A sample without PR or CD was prepared as a control system. The dried material was hot-pressed in a 6 mm thick mold at 160° C. for 10-15 min. A control sample was prepared identically except that no polyrotaxane or CD was added.

Uniaxial compression tests were conducted using MTS Insight (Registered Trademark) universal testing machine at a crosshead speed of 1.3 mm/min according to the ASTM D695-10 standard. The specimens were cut with a diamond saw blade to the nominal dimensions of 12 mm×6 mm×6 mm, Polishing paper with 2400 grit was used to ensure the surfaces were flat and parallel to each other. Lubricant was applied on the compression fixture to minimize friction during the test. At least three samples were tested for each specimen.

### Results

Table 6 shows the yield stress, compressive strength and compressive modulus of neat PMMA, PMMA_CD1%, PMMA_uPR1% and PMMA_mPR1%. The compressive modulus is similar among the samples. The yield stress increase with the addition of both types of polyrotaxanes. The compressive strength is significantly improved by adding 1 phr of modified polyrotaxane to PMMA.

TABLE 6

| | Yield | Compressive | Compressive |
|---|---|---|---|
| | Stress (MPa) | Strength (MPa) | Modulus (GPa) |
| Neat PMMA | 95 ± 4 | 154 ± 10 | 4.1 ± 0.3 |
| PMMA_CD1% | 85 ± 5 | 77 ± 8 | 3.9 ± 0.3 |
| PMMA_uPR1% | 96 ± 1 | 68 ± 5 | 4.1 ± 0.2 |
| PMMA_mPR1% | 110 ± 2 | 191 ± 12 | 4.3 ± 0.1 |

6. Light Transmittance of PMMA Films after Hot-Press

The optical transparency of the 1 mm thick PMMA films molded at 160° C. was investigated using an ultraviolet-visible spectrometer (Shimadzu, UV-3600) for visible wavelengths from 400-700 nm.

### Results

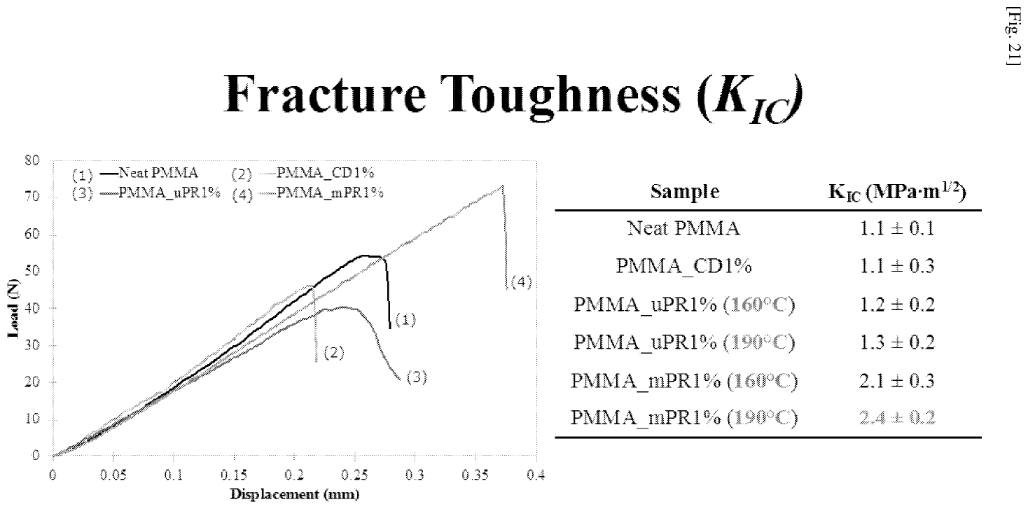

As shown in FIG. 20, the percent light transmission for all samples raised from 80% at 400nm to 90% at 700 nm with experimental error.

### 7. Fracture Toughness

Polyrotaxane (0.11g, SM1303P from Advanced Softmaterials Inc.) was dissolved in 20 mL tetrahydrofura.n (TI-IF). The solution was added dropwise to a solution of 11 g polymethyl-methacrylate (PMMA) in 60 mL THF in oil bath heating at 50° C. and was stirred for 10-20 min. The mixture was sonicated for 15 min and was poured in an aluminum foil mold. The solvent was removed by placing in oven at 85° C. for at least 24 hr. The dried material was hot-pressed. in a 3 mm thick mold at 160° C. for 10-15 min. Identical procedures were followed for 1 phr polyrotaxane (SH1300P) (PMMA_uPR1%), 1phr cyclodextrin (PMMA_CD1%), and a sample without polyrotaxane (neat PMMA).

A single-edge-notch three-point-bending (SEN-3PB) test was used to obtain the mode I critical stress intensity (K_{IC}) of neat PMMA, PMMA_CD1%, PMMA_uPR1% and PMMA/mPR1%. The test was performed on MTS Insight (Registered Trademark) universal testing machine at a crosshead speed of 5 mm/min. Care was taken to ensure that the initial crack, generated by tapping with a fresh razorblade chilled with liquid nitrogen, exhibited a thumbnail shape crack front prior to testing. At least five specimens were used to determine Kic of PMMA/PR specimens. The critical stress intensity factor was calculated using the following equation:

$${K}_{IC} = \frac{{P}_{c} S}{{BW}^{\frac{3}{2}}} f ( \frac{a}{W} )$$

where Pc is the load at crack initiation, S is the span width, B is the thickness of the specimen, f(a/W) is the hinge factor, W is the width of the specimen, and a is the initial crack length.

### Results

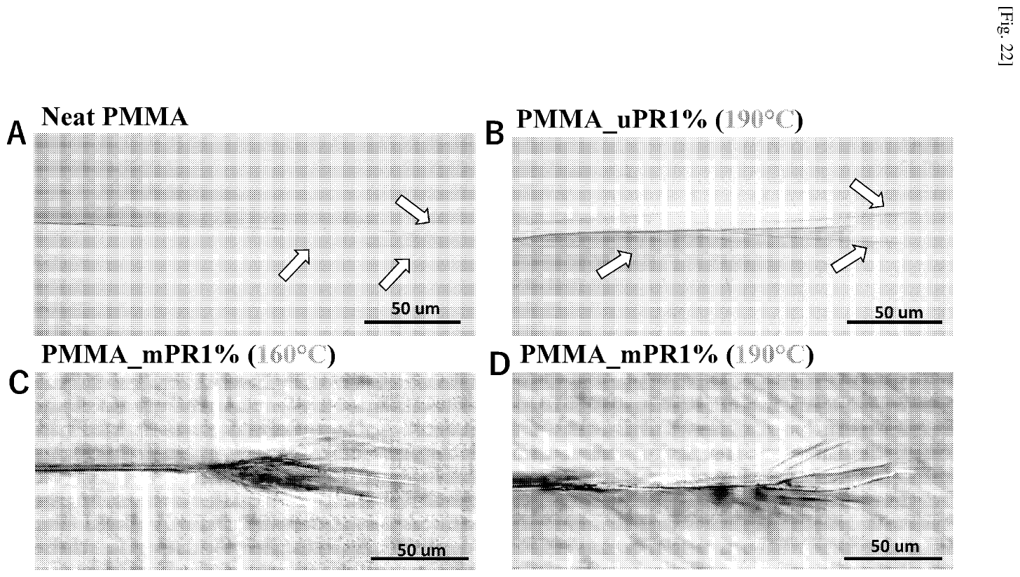

As shown in FIG. 21, The fracture toughness (Kw) improved from 1.1±0.1 to 2.1±0.3 MPa.m^{1/2} with added polyrotaxane and pressed at 160° C.

### 8. Fracture Mechanisms Investigation—Double-Notch Four-Point Bend (DN-4PB) Test

DN-4PB test was used to probe toughening mechanisms. For the details of DN-4PB test, see Liu Jia, et al, Macromolecules 41.20(2008): 7616-7624. Two nearly identical cracks are cut into the same edge of a rectangular specimen. Once loaded, one of the cracks will reach the critical state first and propagate, thus leaving the remaining crack to develop a subcritical crack tip damage zone. Key fracture mechanisms can be identified in the arrested crack tip damage region. Regions for TEM were embedded in an epoxy mount, stained with O_{S}O₄ crystals for 6 hours and rinse in water for 12 hours.

### Results

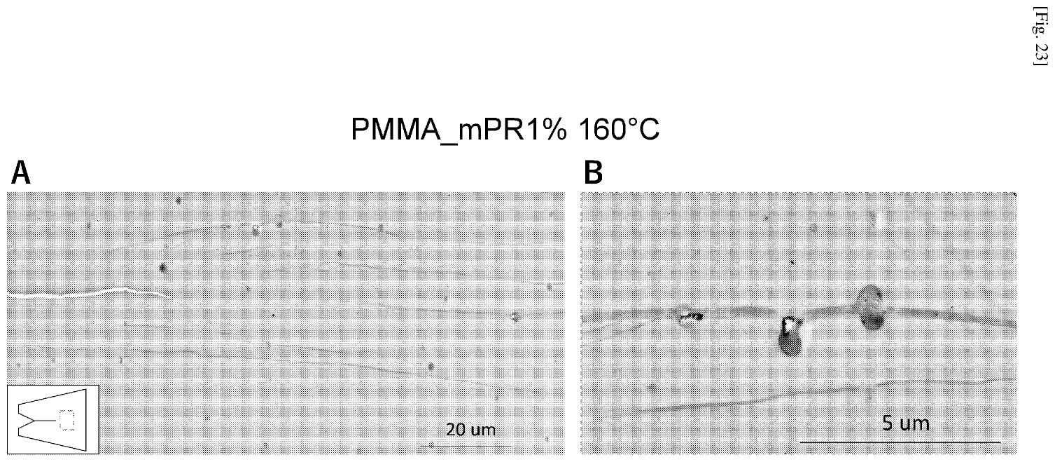

FIG. 21 shows the damage zone at the crack tip of the samples by optical microscopy. FIG. 22 (A-B) show minimal craze formation in neat PMMA and PMMA_uPP1%. FIG. 22 (C-D) show significant craze formation for PMMA_mPR1% pressed at 160° C. and at 190° C.

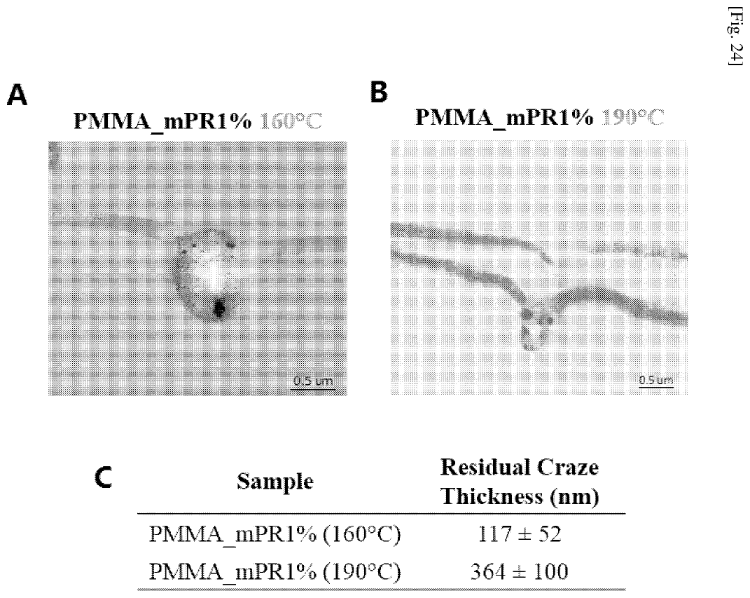

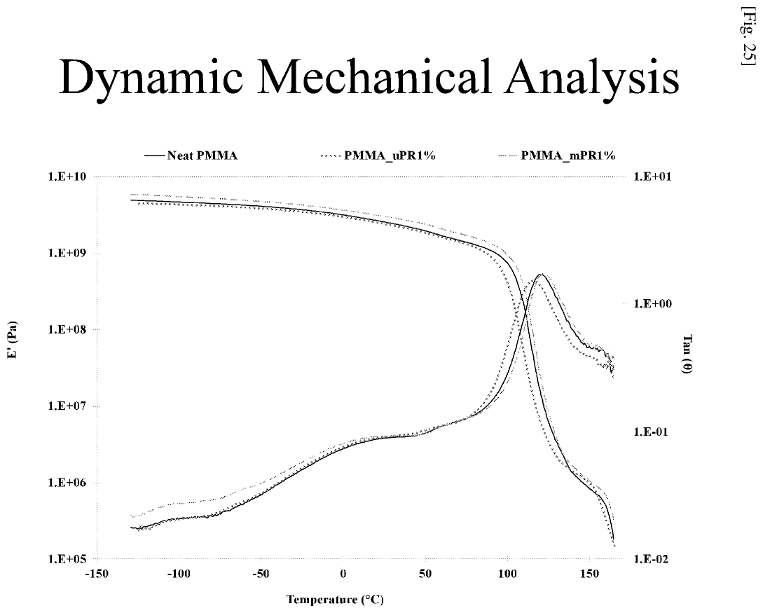

FIGS. 23A and 23B show the damage zone near the crack tip by transmission electron microscopy for PMMA_mPR1% hot-pressed at 160° C. The massive craze formation may be responsible for the significant improvement in fracture toughness. FIGS. 24A and 24B show the residual craze thickness for PMMA milkl% pressed at 160° C. and 190° C., respectively. The residual craze thickness is higher for the sample hot-pressed at 190° C., which may be responsible for the improvement in fracture toughness in comparison to the sample processed at 160° C.,

### 9. Dynamic Mechanical Analysis (DMA)

DMA was performed using an RSA G2 instrument (TA Instruments), using a temperature range from −120 to 165°C. at a fixed frequency of 1 Hz: and a constant ramp rate of 5°C./min. A sinusoidal strain amplitude of 0.05% was chosen for the analysis. The dynamic storage modulus (E′) and tan δ curves were plotted as a function of temperature. The temperature at the peak in the tan δ curve was recorded as the Tg.

### Results

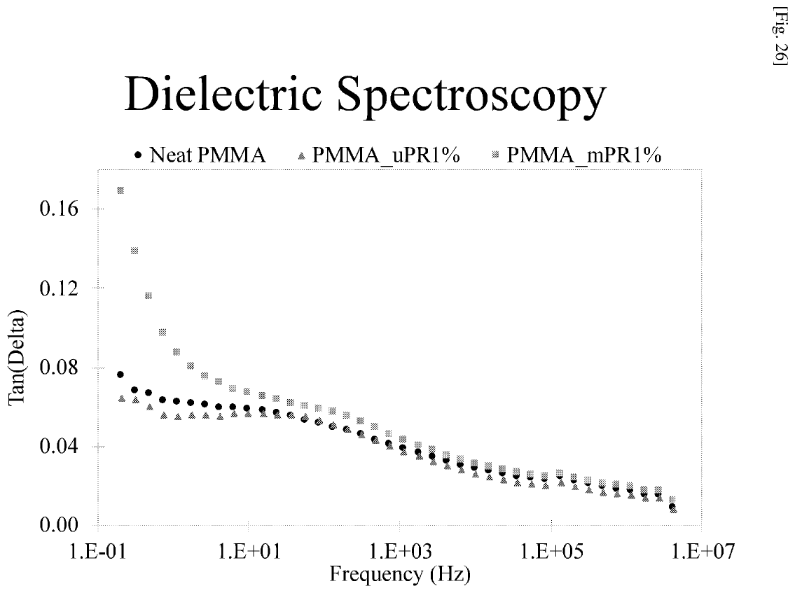

FIG. 25 shows curves of dynamic storage modulus (E′) and tan δ versus temperature. The Tgs of Neat PMMA, PMMA_uPR1% and PMMA_mPR1% were 121, 117, and 123° C. respectively. Adding unmodified PR to PMMA slightly decreased the Tg. The sub-Tg relaxation was significantly more pronounced in PMMA_mPR1.

### 10. Dielectric Spectroscopy

Dielectric loss was measured as a function of frequency using a dielectric spectrometer. The dielectric loss of Neat PMMA, PMMA_uPR1% and PMMA_mPR1% was measured at 30° C. at a frequency range of 0.1 to 1E+07 Hz.

### Results

As shown in FIG. 26, the dielectric loss of PMMA_mPR1% was significantly higher than Neat PMMA and PMMA_uPR1% in the low frequency range, suggesting there is a longer range coupling between triPR and the PMMA matrix by introducing methacrylate functional group on CD in the PR structure. The dielectric loss of Neat PMMA and PMMA uPR1% are similar throughout the entire frequency range.

Based on our DMA and dielectric loss measurements, it is quite evident that mPR does couple with PMMA matrix extensively. In contrast, uPR, does not seem to show molecular scale mobility coupling with PMMA. This indicates that the methacrylate functionalized CDs in PR have interacted with PMMA. and caused PMMA molecules to exhibit significantly more damping. This may be the key finding that led to the greatly improved scratch performance and fracture toughness

1. A composition comprising,
a thermoplastic polymer and a polyrotaxane;
wherein the polyrotaxane a plurality of cyclic molecules and a chain polymer passing through the plurality of the cyclic molecules in a skewering manner, wherein at least a part of the hydroxyl groups of each of the plurality of cyclic molecules is substituted with a hydrophobic group, wherein a group that enhances miscibility of the polyrotaxane to the thermoplastic polymer is bound to at least a part of the hydrophobic groups of each of the plurality of cyclic molecules.

2. The composition of claim 1, wherein the polyrotaxane couples with the thermoplastic polymer.

3. The composition of claim 1, wherein the composition has the structure in which a plurality of discontinuous phases of particles containing the polyrotaxane are present in a continuous phase of the thermoplastic polymer and a part of or a whole of the plurality of discontinuous phases have the structure in which particles of the polyrotaxane are dispersed in the thermoplastic polymer, in the field of view of 5×5 μm² by transmission electron microscopy.

4. The composition of claim 1, wherein more than 20% of the hydroxyl groups out of the total number of the hydroxyl groups of the plurality of cyclic molecules are substituted with the hydrophobic group.

5. The composition of claim 1, wherein the chain polymer passing through the plurality of the cyclic molecules in a skewered manner has the weight average molecular weight of 20,000 or less.

6. The composition of claim 1, wherein the composition includes 10 wt. % or less of the polyrotaxane.

7. The composition of claim 1, wherein the thermoplastic polymer includes polymethacrylate, polycarbonate, polyester, poly(ethylene terephthalate), polystyrene or a combination thereof.

8. The composition of claim 1, wherein the thermoplastic polymer includes polymethyl methacrylate, polypropylene, or poly(ethylene terephthalate).

9. The composition of claim 1, wherein the cyclic molecules include cyclodextrin.

10. The composition of claim 1, wherein the hydrophobic group includes a polyester, alkyl, polyether, or unsaturated hydrocarbon.

11. The composition of claim 1, wherein the group that enhances miscibility of the polyrotaxane to the thermoplastic polymer includes a monomer of the thermoplastic polymer.

12. The composition of claim 1, wherein the visible crack onset load of the composition having a thickness of 1 mm is 80 N or more when measured with a 1 mm scratch tip in accordance with the ASTM D7023-13/ISO19252:2008 scratch test.

13. The composition of claim 1, wherein the mode I critical stress intensity (K_{IC}) of the composition is 1.5 MPa.m^{1/2} or higher in single-edge-notch three-point-bending (SEN-3PB) test.

14. The composition of claim 1, wherein the composition has light transmittance of not less than 85% at a wavelength of ranging from 400 to 700 nm at a 1 mm film thickness.

15. A molded article comprising the composition of claim 1.

16. A film comprising the composition of claim 1.

17. A method of producing a composition comprising a thermoplastic polymer and a polyrotaxane, the method comprising
providing a polyrotaxane including a plurality of cyclic molecules and a chain polymer passing through the plurality of the cyclic molecules in a skewering manner, wherein at least a part of the hydroxyl groups of each of the plurality of cyclic molecules is substituted with a hydrophobic group, wherein a group that enhances miscibility of the polyrotaxane to the thermoplastic polymer is bound to at least a part of the hydrophobic groups of each of the plurality of cyclic molecules; and
blending the thermoplastic polymer and the polyrotaxane.

18. The method of claim 17, wherein the blending includes melt-mixing the thermoplastic polymer and the polyrotaxane.

19. The method of claim 17, wherein the blending includes blending the thermoplastic polymer and the polyrotaxane in a solvent and the method further comprises removing the solvent after the blending step.

20. The method of claim 17, further comprising molding the blend of the thermoplastic polymer and the polyrotaxane after the blending step.
